(19) United States
(12) Patent Application Publication
(10) Pub. No.: US 2022/0036271 A1
(43) Pub. Date: Feb. 3, 2022

(54) WORKFLOW MANAGEMENT SYSTEM

(71) Applicant: Citrix Systems, Inc., Fort Lauderdale, FL (US)

(72) Inventors: Gregg Thomason, Hitchin (GB); Kristian Gregory, Hitchin (GB); Daniel Peacock, Ely (GB); Daniel Thorpe, St. Neots (GB)

(21) Appl. No.: 16/941,226

(22) Filed: Jul. 28, 2020

(51) Int. Cl. G06Q 10/06; G06Q 10/10; H04L 12/58

(52) U.S. Cl. CPC G06Q 10/06316; H04L 51/24; G06Q 10/103

(57) ABSTRACT

One example disclosed method involves a computing system receiving first data from a first application and second data from a second application. The first data may have a first format and be indicative of a first task, and the second data may have a second format different from the first format, and may be indicative of a second task. The computing system may determine, based in part on a first characteristic of the first data, a first client device to which a first indication of the first task is to be provided. The computing system may send, to the first client device, the first indication. The first indication may have a same format as a second indication of the second task sent to the first client device or a second client device. The same format may provide a uniform presentation of information relating to the first and second tasks.

### BACKGROUND

Various systems have been developed that allow client devices to access applications and/or data files over a network. Certain products offered by Citrix Systems, Inc., of Fort Lauderdale, Fla., including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves receiving, by a computing system, at least first data from a first application and second data from a second application, wherein the first data has a first format and is indicative of a first task, and the second data has a second format, different from the first format, and is indicative of a second task; determining, based at least in part on a first characteristic of the first data, a first client device to which a first indication of the first task is to be provided; and sending, to the first client device, the first indication, the first indication having a same format as a second indication of the second task sent to the first client device or a second client device, the same format providing a uniform presentation of information relating to the first and second tasks.

In some disclosed embodiments, a method may involve receiving, by a computing system, at least first data from a first application and second data from a second application, wherein the first data has a first format and is indicative of a first task, and the second data has a second format, different from the first format, and is indicative of a second task; determining first and second instances of a data structure for storing characteristics of the first and second tasks, respectively, wherein the first and second instances both include a same plurality of fields for storing values indicative of respective task characteristics; populating a first field of the first instance with a first value, the first field representing a first characteristic of the first task; and sending, to a first client device, a first message indicating assignment of the first task to a first individual.

In computing system comprising at least one processor and at least one computer-readable medium encoded with instructions which, when executed by the at least one processor, cause the computing system to receive, by a computing system, at least first data from a first application and second data from a second application, wherein the first data has a first format and is indicative of a first task, and the second data has a second format, different from the first format, and is indicative of a second task; determine, based at least in part on a first characteristic of the first data, a first client device to which a first indication of the first task is to be provided; and send, to the first client device, the first indication, the first indication having a same format as a second indication of the second task sent to the first client device or a second client device, the same format providing a uniform presentation of information relating to the first and second tasks.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is a diagram illustrating certain features of an example of a workflow management system configured in accordance with some embodiments of the present disclosure;

FIG. 1B is a diagram illustrating certain features of another example of a workflow management system configured in accordance with some embodiments of the present disclosure;

FIG. 2 is a diagram of a network environment in which some embodiments of the workflow management system disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment;

FIG. 5C is a block diagram similar to that shown in FIG. 5B but in which the available resources are represented by a single box labeled “systems of record,” and further in which several different services are included among the resource management services;

FIG. 5D shows how a display screen may appear when an intelligent activity feed feature of a multi-resource access system, such as that shown in FIG. 5C, is employed;

FIG. 6 is a block diagram of a workflow management system, such as that introduced in connection FIGS. 1A and 1B, that is implemented in connection with a multi-resource access system, such as that described in connection with FIG. 5C;

FIG. 7A is a flowchart illustrating an example structure of a rule for an adapter of a workflow management system;

FIG. 7B is a flowchart illustrating an example rule for an adapter of a workflow management system;

FIG. 8A is a flowchart illustrating an example process for assigning an actionable work item;

FIG. 8B is a flowchart illustrating an example process for setting a priority for an actionable work item;

FIG. 9 is a flowchart illustrating an example process for estimating a size of an actionable work item;

FIG. 10 is a flowchart illustrating an example process triggered by a change to a work item;

FIG. 11 is a flowchart illustrating an example process for estimating a size of an actionable work item; and

FIG. 12 is a flowchart illustrating an example filtering process for detecting triggering events in received data.

### DETAILED DESCRIPTION

For purposes of reading the description of the various embodiments below, the following descriptions of the sections of the specification and their respective contents may be helpful:

Section A provides an introduction to example embodiments of a workflow management system configured in accordance with some embodiments of the present disclosure;

Section B describes a network environment which may be useful for practicing embodiments described herein;

Section C describes a computing system which may be useful for practicing embodiments described herein;

Section D describes embodiments of systems and methods for delivering shared resources using a cloud computing environment;

Section E describes embodiments of systems and methods for managing and streamlining access by clients to a variety of resources;

Section F provides a more detailed description of example embodiments of the workflow management system introduced above in Section A;

Section G describes example implementations of methods, systems/devices, and computer-readable media in accordance with the present disclosure.

### A. Introduction to Illustrative Embodiments of a Workflow Management System

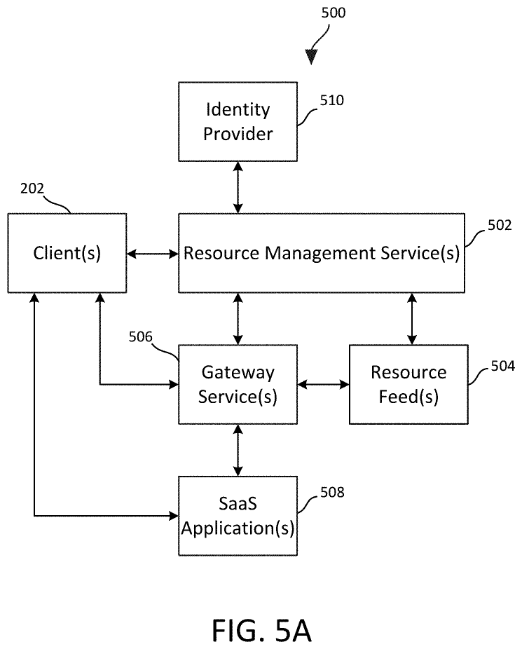

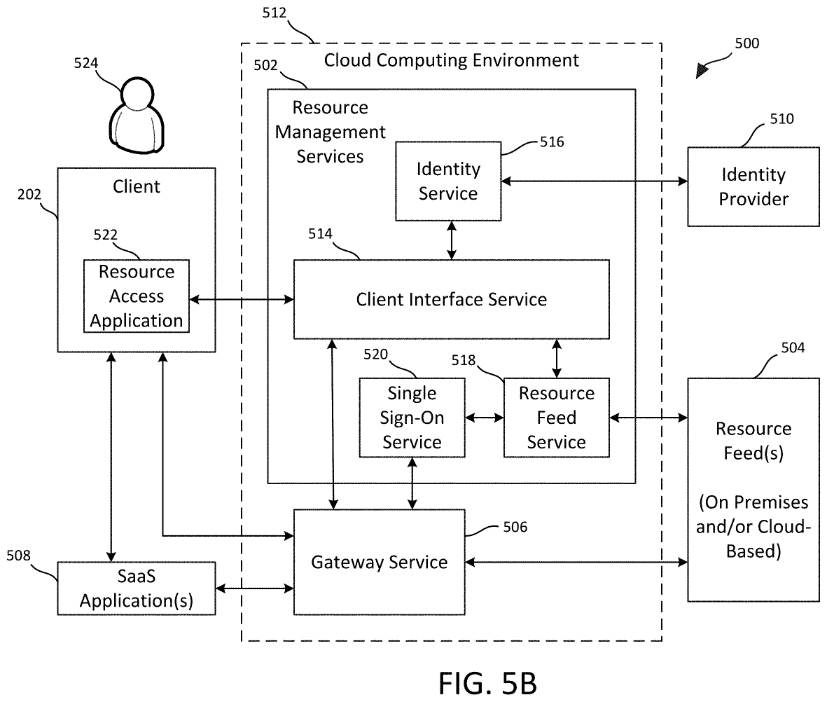

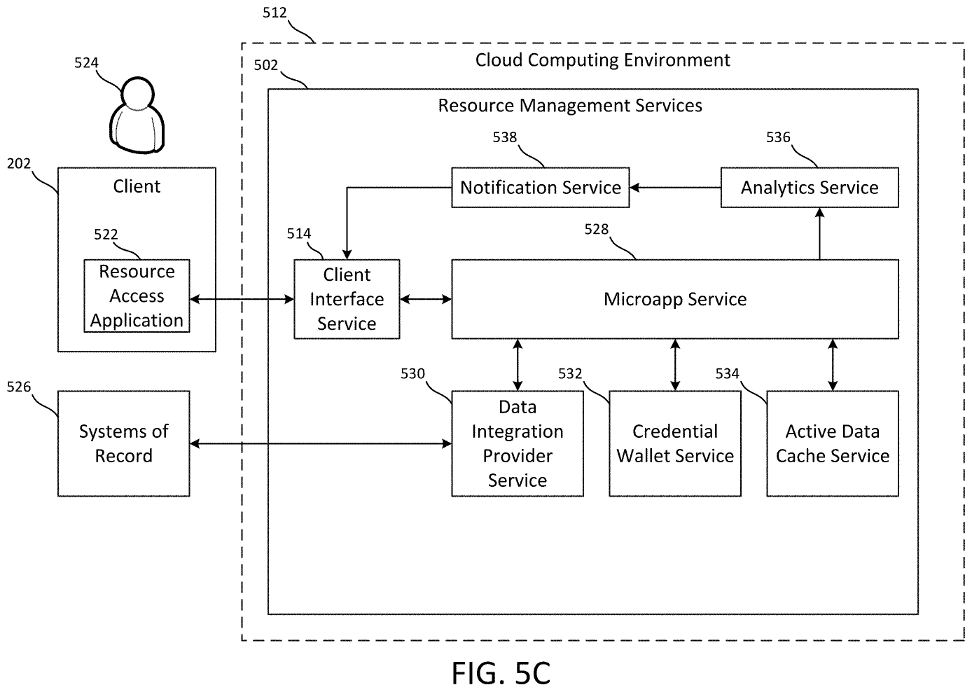

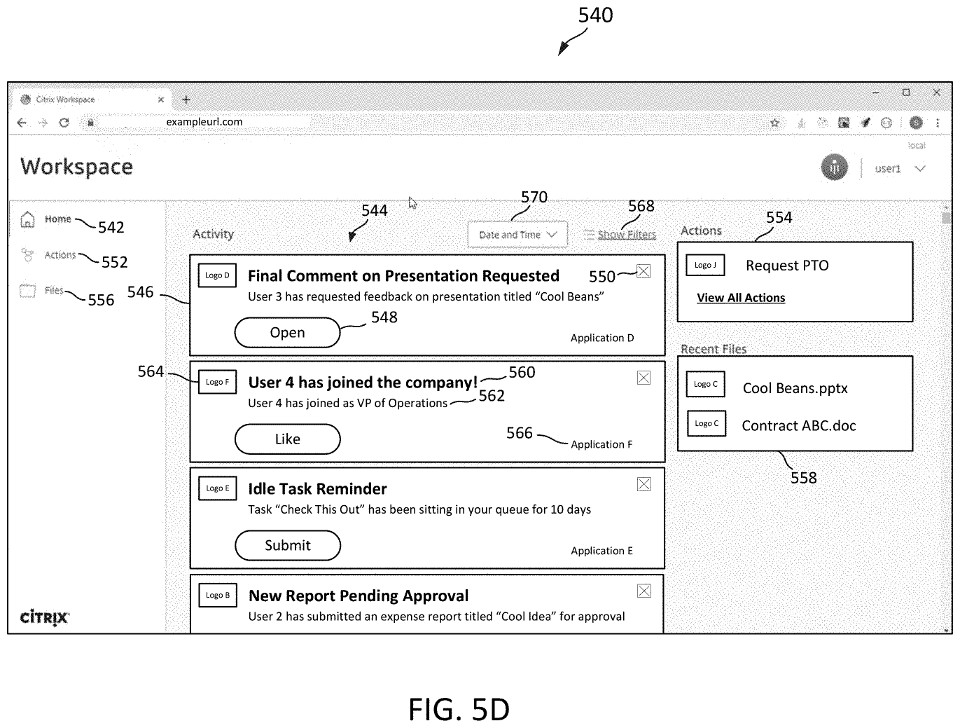

As described below (in Section E) in connection with FIGS. 5A-D, a multi-resource access system 500 may provide a client device 202 with access to one or more resource feeds 504 (e.g., via one or more gateway services 506) and/or one or more software-as-a-service (SaaS) applications 508. In FIG. 5C, the applications corresponding to such resource feeds 504 and/or SaaS applications 508 are represented, collectively, by a single block 526, labeled “systems of record.” As Section E describes, various resource management service(s) 502 may employ an identity provider 510 to authenticate the identity of a user 524 of a client device 202 and, following authentication, identify one or more resources the user 524 is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

Examples of SaaS applications include GOOGLE APPS provided by Google Inc., SALESFORCE provided by Salesforce.com Inc. of San Francisco, Calif., or OFFICE 365 provided by Microsoft Corporation. Examples of SaaS applications may also include office communication platforms such as TEAMS provided by Microsoft Corporation, and SLACK provided by Slack Technologies, Inc. of San Francisco, Calif. Examples of SaaS applications may also include productivity management platforms such as JIRA provided by Atlassian Corporation Plc of Sydney, Australia, and NOW PLATFORM provided by ServiceNow, Inc. of Santa Clara, Calif.

In a modern workplace environment, work assignments may be communicated digitally between users via communications applications and/or productivity management applications, such as those mentioned above, or otherwise. A user may be a requestor and/or an assignee, where a requestor may be a user assigning a work item and a assignee may be user acting upon the work item. A work item may represent an electronic record of a task to be performed by a assignee, including metadata fields indicating characteristics of the task, such an assignee ID (e.g., an assignee who has been assigned to complete the task and has accepted the task), a requestor ID (e.g., a manager who is requesting performance of the task), task description, priority, an estimated size (e.g., an estimated time to complete), skills required (e.g., a professional credential or a programming language), resources required (e.g., hardware and/or software resources that may be in limited supply), a due date, and/or an estimated completion date, etc. Requestors and assignees may use a multi-resource access system 500 to access respective resources, e.g., by operating resource access applications 522 of respective client devices 202 as described below in connection with FIGS. 5B and 5C, to communicate with one another about work items and to perform tasks relating to the same. For example, a requestor may send a work item to an assignee using, for example, email, intra-office text-based chat, or a productivity management application accessible via the multi-resource access system 500. The assignee may receive the work item and act upon it; for example, by accepting, declining, or requesting a modification of the work item.

The content and format of a work item may vary by application. For example, in the case of productivity management, applications may represent work size, priority, and resources needed differently. Information transmitted from/to respective applications may include some pieces of data and exclude others. Some work items may be sent more informally than others; for example, an email stating, “Can you please handle . . . ?” Due to the lack of uniformity, a multi-resource access system 500 generally provides concurrent access to the respective applications. Doing so, however, may be costly in terms of computing resources. Furthermore, providing concurrent access to multiple applications may result in cluttered interfaces for requestors and assignees. And assignees may be burdened with having to learn how to monitor and/or respond to work items for many different applications.

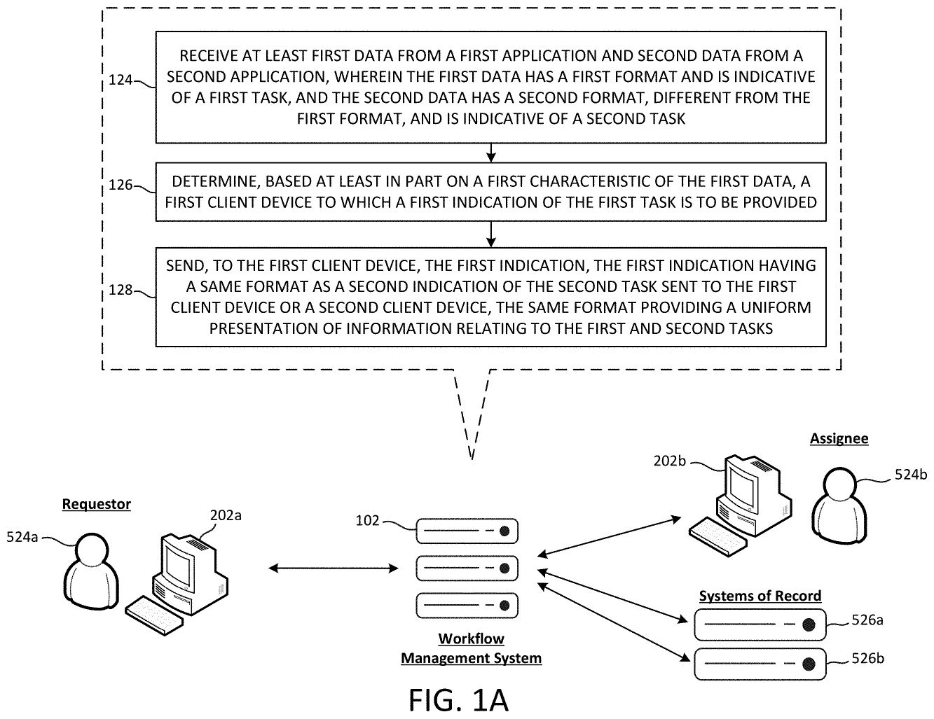

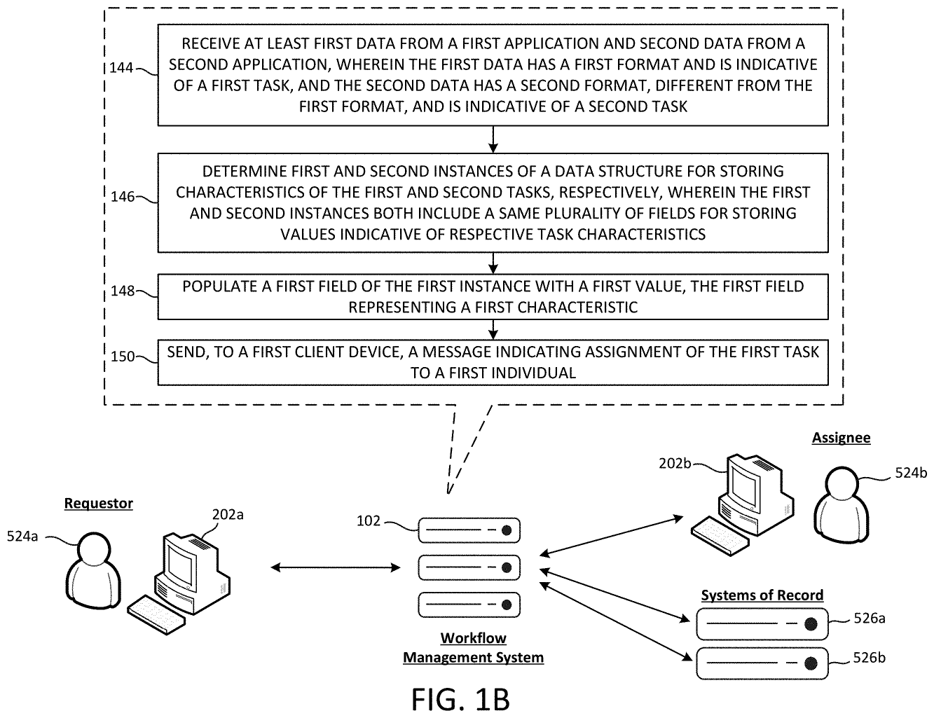

Offered is a workflow management system that is capable of automatically acquiring and processing data from multiple, different applications to seamlessly identify and route work items to respective users. Example implementations of such a workflow management system 102 are shown in FIGS. 1A and 1B. As shown, a first user 524a (labeled a “requestor”) may operate a first client device 202a to assign a work item to a second user 524b (labeled a “assignee”) operating a second client device 202b. The different applications may include systems of record 526 that are offered by entities other than the one operating the workflow management system 102. The workflow management system 102 may determine that the data from the application(s) describes a work item, and may extract a characteristic of the work item from the data. The workflow management system 102 may then assign the work item to an individual 524b based on the characteristic, and may cause one or more client devices 202a, 202b to output a notification concerning the work item. In some implementations, such notifications may be included amongst the notifications 546 that are presented in an activity feed 544 of a client device 202, as described below in connection with FIG. 5D.

The workflow management system 102 may also be capable of converting the data from respective systems of record 526a, 526b into a predetermined, common format. Converting the data into a common format may allow the workflow management system 102 to employ a uniform process to evaluate data relating to work items to determine whether and/or how to assign work items to individuals and/or to generate notifications 546 relating to such work items in a common format, regardless of variances in the content and/or format of the data that is received from the various systems of record 526a, 526b. The predetermined format may include a plurality of fields for characteristics of a work item described by the data. In some implementations, the workflow management system 102 may retrieve additional data from different systems of record 526a, 526b and use it to estimate additional characteristics of a work item; for example, an estimate of time to completion, a priority, and/or a potential relevant assignee.

A requestor 524a or a assignee 524b who receives a notification 546 regarding a work item from the workflow management system 102 may respond to the notification 546, e.g., using the resource access application 522 (shown in FIGS. 5B and 5C), to accept, decline, or modify the work item. In some implementations, the notification 546 may be pushed to a resource access application 522 without a specific request from a user 524a, 524b. A notification 546 may, for example, include a request to revise a priority, an estimated size, and/or an estimated completion date. The workflow management system 102 may update a record of the work item, and may propagate an update to the requestor 524a, the assignee 524b, and/or a system of record 526.

In some implementations, a notification 546 may include an action element, such as a link or button that a user may activate to respond to the notification. Activating the action element—e.g., by clicking with a mouse, selecting and entering with a keyboard, touching on a touchscreen, etc.—may cause the resource access application 522 to send the response to the workflow management system 102. In some implementations, clicking the action element may invoke a micro-application, or “microapp.” As described below in connection with FIGS. 5C and 5D, a microapp may, for example, be an interactive software module that allows a user to interface with a system of record 526 indirectly, e.g., via an application programming interface (API) for the system of record 526. The microapp may be a small, task-specific application configured to deliver targeted functionality. The microapp may allow a user to accomplish a single-purpose activity in a simple and efficient manner. For example, a microapp may deliver actionable forms and/or notifications 546 to a client device 202, and may also write back to source systems (e.g., the multi-resource access system 500 and/or a systems of record 526). A microapp may allow a user to interact with an application executing on a system of record 526 in a limited manner without performing a full launch of the application. Thus, upon receiving a notification 546, a user 524a, 524b may respond by activating an action element, which may invoke a microapp to propagate the response to the multi-resource access system 500, and possibly to another client device 202 and/or a system of record 526 as well. For example, the microapp may be configured to update a record of the work item in the workflow management system 102, and/or may cause the workflow management system 102 to send a notification 546 regarding the response to a another client device 202, such as the client device 202a operated by the requestor 524a of the work item.

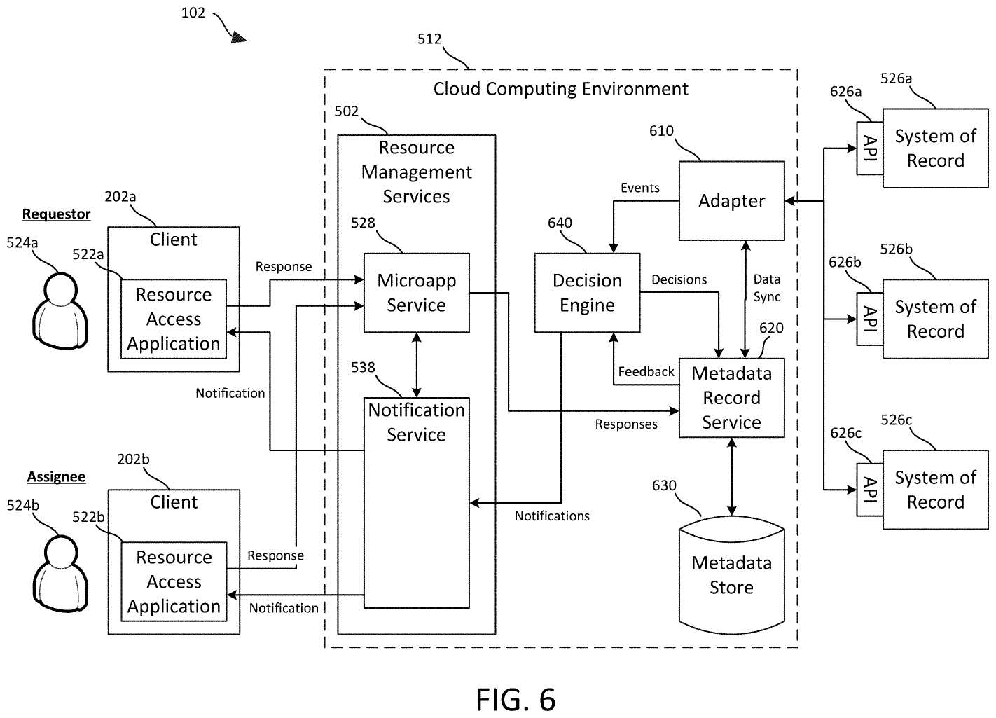

FIG. 1A is a diagram illustrating certain features of a first example implementation of a workflow management system 102 configured in accordance with some embodiments of the present disclosure. The workflow management system 102 may, among other capabilities, standardize work item delivery and automate status updates regarding the work items. A work item may represent a record of a task, and may include metadata fields indicating one of various characteristics of the task. For example, a work item may represent an electronic representation of a task that is assigned by the requestor 524a to the assignee 524b. Although the illustrated example shows the workflow management system 102 as including three servers, it should be appreciated that the workflow management system 102 may include any number of servers (including only a single server) as well as any number of additional or different components, such as one or more databases, other network components, etc. In some embodiments, the workflow management system 102 may be implemented within a multi-resource access system 500 (such as that described in Section E below) and, as such, may provide the client devices 202a and 202b (collectively, “client devices 202”) with access to applications hosted by various systems of record 526, such as the systems of record 526a and 526b shown in FIGS. 1A and 1B. The client devices 202 may be personal computers, mobile devices such as tablets or mobile phones, or thin clients. In some implementations, the workflow management system 102 may provide the client device 202 with services beyond its hardware capabilities, and/or provide secure access to the files and applications on the workflow management system 102. For example, the workflow management system 102 may host files and execute applications, and may provide an environment to the client device 202 that allows a user to access the files and applications as though they existed locally on the client device 202. The workflow management system 102 may host some applications itself, while other applications may be hosted by third-party systems of record 526a and 526b. The systems of record 526 are described in additional detail below with reference to FIGS. 5C and 6.

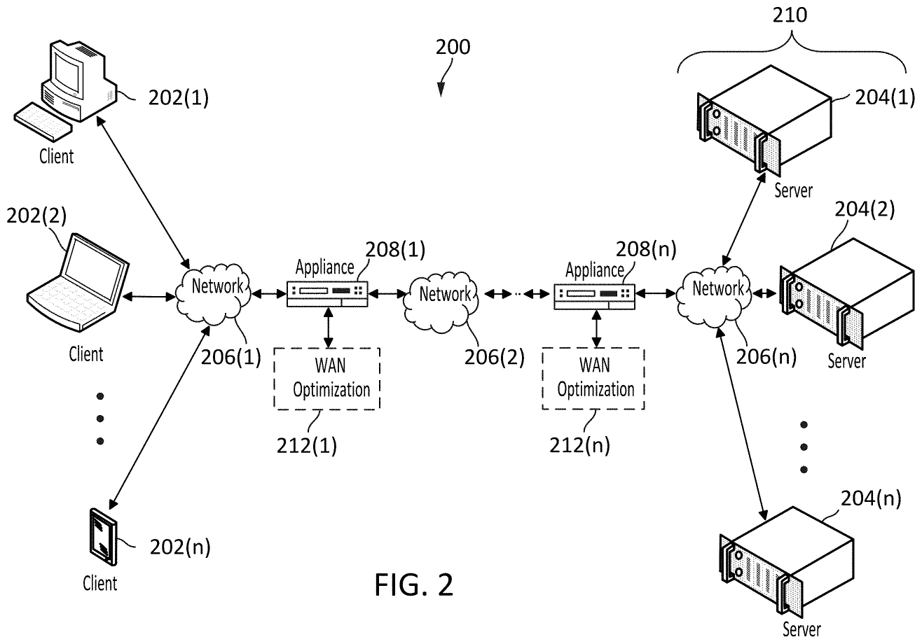

As noted above, in some implementations, the client device 202 may access services of the workflow management system 102 using the resource access application 522 shown in FIGS. 5B and 5C. The workflow management system 102 may include multiple integrated and/or interconnected components as described in FIGS. 2-4 and 5A-5D. For example, the workflow management system 102 may be the implemented within or operate in conjunction with the multi-resource access system 500 described in connection with FIGS. 5A-5C. Operations of the workflow management system 102 are described below, and in further detail in Section F with reference to FIGS. 6 through 11.

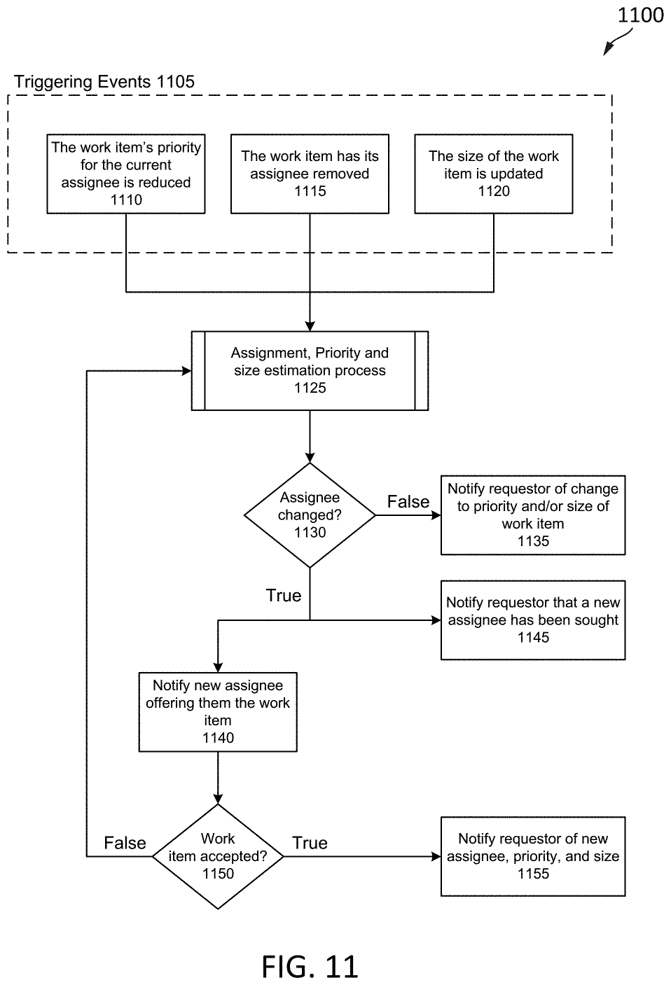

As shown in FIG. 1A, the workflow management system 102 may, at a step 124, receive data from a plurality of different applications executing on one or more systems of record 526. The received data may include first data from a first application and second data from a second application. The first data may a first format and may be indicative of a first task. The second data may a second format different from the first format, and may be indicative of a second task. The first application and/or second application may be, for example, a SaaS application, or another type of application, provided by a system of record 526, as described in connection with FIGS. 5A-5D and 6. The data may, for example, be in the form of messages sent via one or more communications applications and/or tasks maintained in one or more productivity management applications. The data may additionally or alternatively represent events that occur within one or more application. Such events may, for example, be detected using APIs of one or more applications. In some implementations, the workflow management system 102 may store login credentials corresponding to one or more users and/or one or more organizations. The workflow management system 102 may use the credentials to access data related to the users and/or organizations from the applications; for example, via APIs. Examples of how the workflow management system 102 may respond to various types of triggering events are described in further detail below with reference to FIG. 11.

In some implementations, the workflow management system 102 may query, periodically or otherwise, the systems of record 526a, 526b for pertinent events, e.g., using access credentials to call one or more API methods of the systems of record 526a, 526b. In some implementations, the workflow management system 102 may additionally or alternatively retrieve data in the form of a bulk data extraction, and subsequently keep up to date by subscribing to the events of various applications. An application may issue an event in response to a creation, modification, or deletion related to a work item; for example, when a requestor creates a work item in a productivity management application. The requestor may create the work item by sending data regarding the task to the application. The application, in response to receiving the data, may create a work item and issue an event to the workflow management system 102.

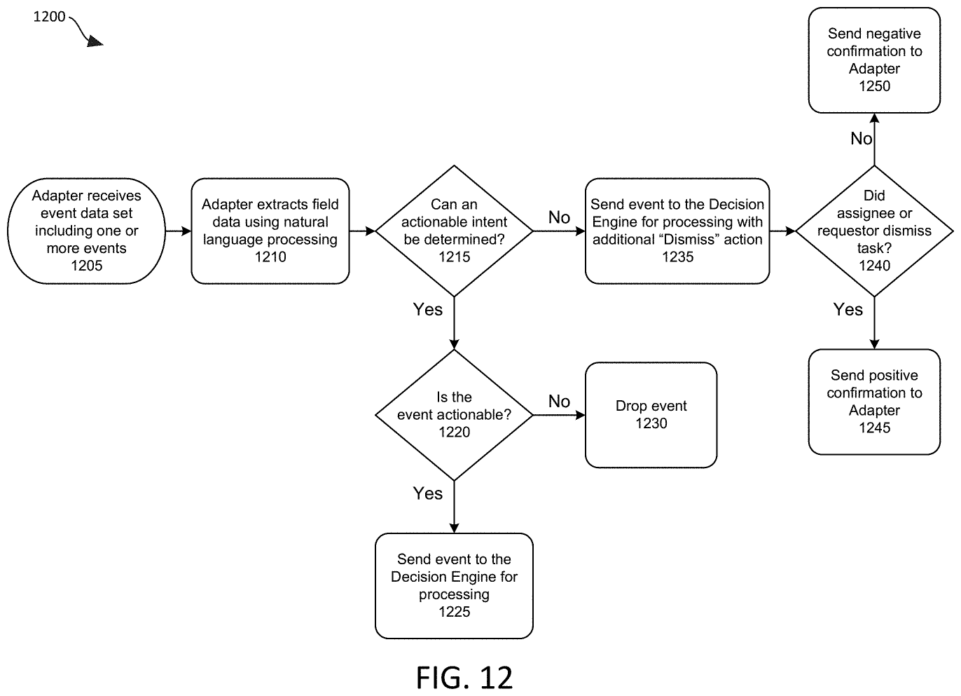

The workflow management system 102 may determine that the first and/or second data is indicative of a task to be performed. The workflow management system 102 may implement a filtering function to determine that an event received from an application pertains to a new or existing work item. For example, for messages sent via communications applications, many or most of the messages may not relate directly to assigning or modifying a task to be performed. In some implementations, the workflow management system 102 may employ machine learning techniques to recognize features of messages (and other events) to determine whether or not they pertain to work items. Examples of how the workflow management system 102 may identify triggering events in received data are described in further detail below with reference to FIG. 12.

The workflow management system 102 may determine, based at least in part on the first data, at least a first characteristic of the first and/or second task. Task characteristics that may be represented in a work item may include, for example and without limitation, an assignee ID, requestor ID, task description, priority, estimated size, skills required, resources required, a due date, and/or an estimated completion date, etc. The workflow management system 102 may determine multiple characteristics of the first and/or second task and use them to populate a record for a work item for the respective task. The workflow management system 102 may, however, leave one or more fields of the work item record null initially.

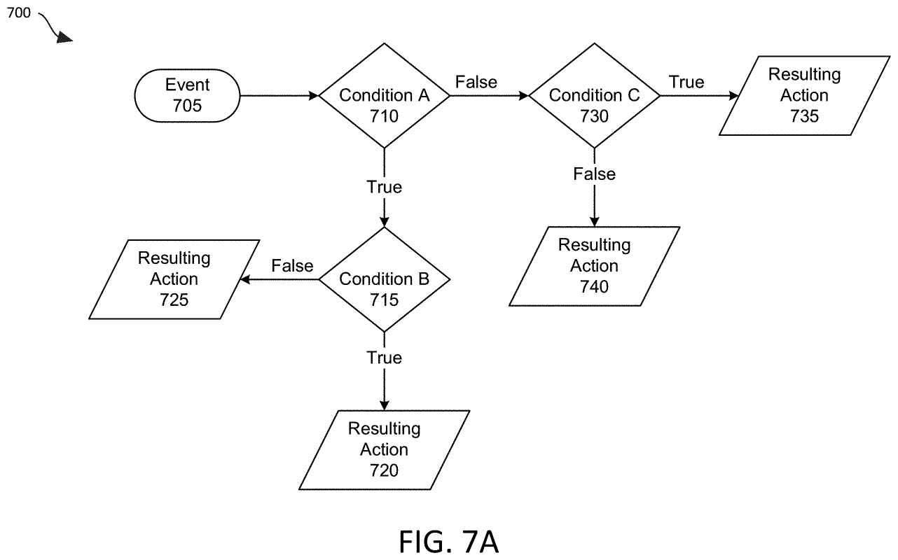

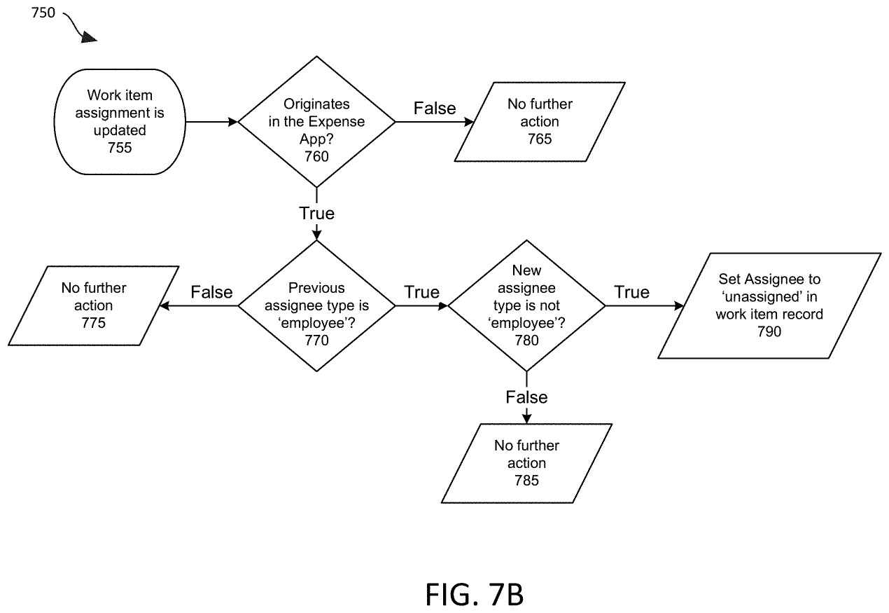

In some implementations, the workflow management system 102 may use additional data to populate other fields of the work item record representing other characteristics. The workflow management system 102 may use, for example, stored historical data regarding previous work items assigned and/or completed, data regarding one or more possible assignees from a human resources management application, and/or data regarding an assignee based on user data for the assignee residing in a third-party application such as a calendar application. Examples of how task characteristics may be determined to populate one or more fields of a work item record are described in further detail below with reference to FIGS. 7 through 10.

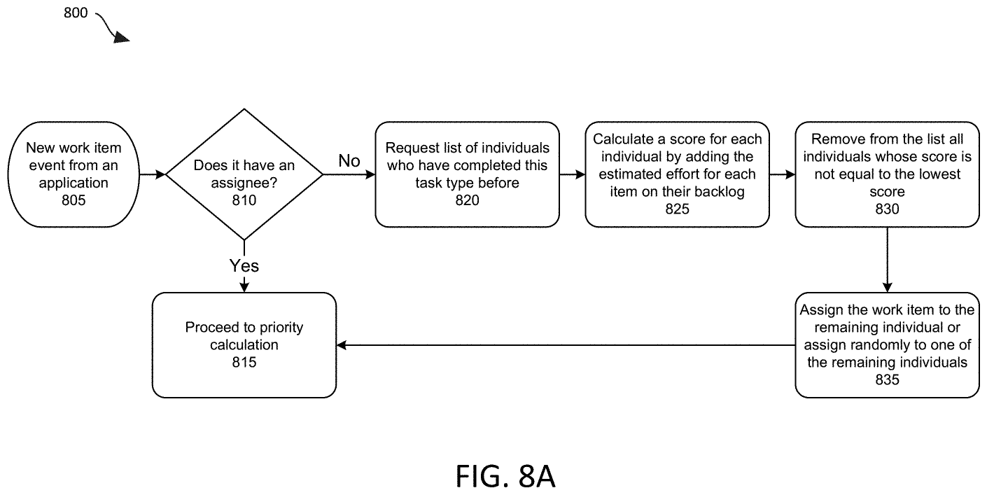

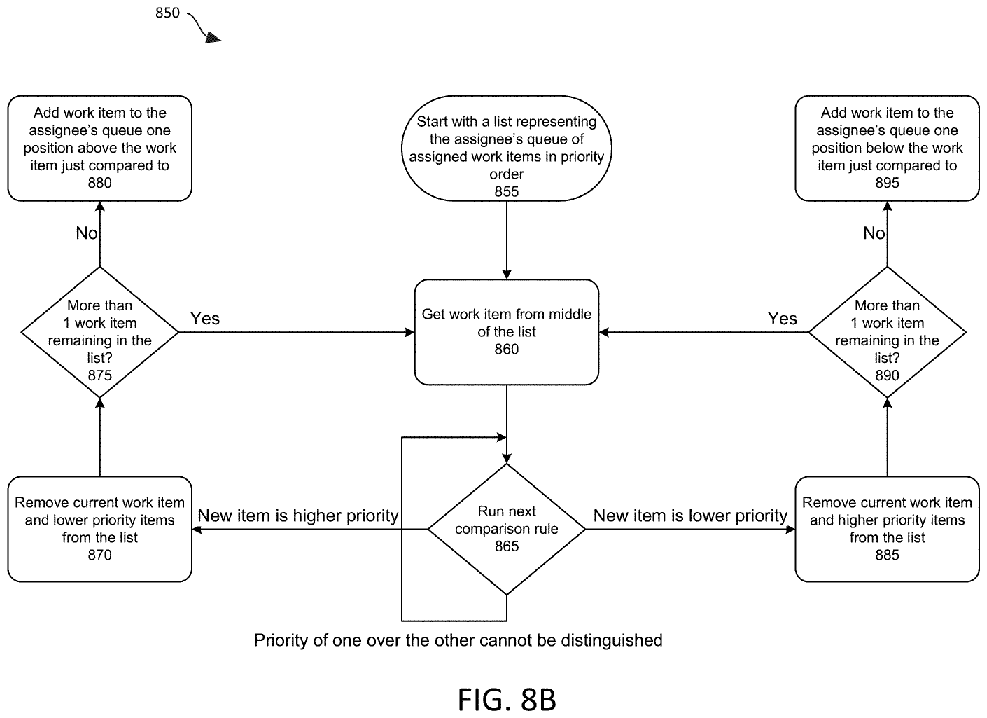

The workflow management system 102 may, at a step 126, determine, based at least in part on the first characteristic, a first client device to which a first indication of the first task is to be provided. In some cases, the requestor 524a may specify a particular assignee, e.g., the assignee 524b, associated with a client device, e.g., the client device 202b. In some cases, the workflow management system 102 may be able to determine an assignee in a relatively straight forward manner by, for example, identifying the recipient of a message. In some cases, the workflow management system 102 may be tasked with identifying a potential assignee based on characteristics of the task, such as skills required and the respective sizes of potential assignees' work backlogs. An example process for selecting an assignee when none has been identified by the requestor 524a is described below with reference to FIG. 8A.

The workflow management system 102 may, at a step 128, send, to the first client device 202b, the first indication. The first indication may have a same format as a second indication of the second task sent to the first client device 202b or a second client device (e.g., the client device 202a). The same format may provide a uniform presentation of information relating to the first and second tasks. The sent first indication may cause the first client device, e.g., the client device 202b, to output an indication that the first task is to be performed by the first individual. Having determined an assignee for the first task, the workflow management system 102 may send a notification 546 (as a part of an activity feed 544, such as shown in FIG. 5D, or otherwise) to a client device 202 of the assignee. In some implementations, the workflow management system 102 may deliver multiple notifications—for example, regarding different work items or events, perhaps issuing from different applications—sharing visual characteristics with one another. The shared visual characteristics can simplify the user's interaction with multiple applications, rather than having to interact with each application separately via different interfaces that may appear and function differently from one another.

In some cases, the notification 546 may include indications of additional task characteristics, such as a proposed priority and/or an estimated size, etc. Each indicated characteristic may include an action element such as a clickable link or button. The action element may provide a mechanism for the recipient of the notification to respond by, for example, accepting, declining, or requesting a modification of the work item. For example, the assignee may accept the work item, but make a change to the estimated size to indicate that the assignee 524b believes that the task may take more or less time to complete. The action element may transmit the acceptance, declination, and/or the modification back to the workflow management system 102. The workflow management system 102 may, based on the response, modify one or more fields of the stored record of the work item. In some implementations, the workflow management system 102 may additionally or alternatively propagate the response to the system of record 526 and/or the client device 202a of the requestor 524a.

In some implementations, action elements and/or notifications 546 may be implemented, for example, using a microapp that can read and/or write data to an application on a systems of record 526 using API functions or the like, rather than by performing a full launch of the application. In some implementations, a user may additionally or alternatively view other details concerning the event that triggered the notification and/or may access additional functionality enabled by the microapp corresponding to the notification (e.g., in a separate, pop-up window corresponding to the microapp) by clicking on or otherwise selecting a portion of the notification 546. Thus, a user may respond by selecting one of the action elements, which activates a microapp at the workflow management system 102 to perform an action in accordance with the response; for example, sending data representing the response, via an API, to an application on a system of record 526. The microapp, per the response selected by the user, may execute an acceptance, declination, or modification of the work item.

In some implementations, the workflow management system 102 may store credentials corresponding to one or more users and/or one or more applications. The workflow management system 102 may use the credentials to access data related to the users and/or organizations to access the applications; for example, via the APIs. The workflow management system 102 may provide the microapp with access to the stored credentials for the purpose of authorizing access to the applications. An application, upon validating the credentials, may accept any requested changes (e.g., to a characteristic of a work item stored by the application) and/or provide any requested data (e.g., events).

FIG. 1B is a diagram illustrating certain features of another example implementation of a workflow management system 102 configured in accordance with some embodiments of the present disclosure. The structural configuration of the workflow management system 102 shown in FIG. 1B may be the same or similar to that of the workflow management system 102 shown in FIG. 1A. The example routines that are illustrated as being performed by the two implementations are, however, slightly different.

As shown in FIG. 1B, the workflow management system 102 may, at a step 144, Receive at least first data from a first application and second data from a second application, such as applications executing on the system of record 526. The first data may have a first format and be indicative of a first task. The second data may have a second format different from the first format, and may be indicative of a second task. Step 144 may be similar to step 124 described above with respect to FIG. 1A.

The workflow management system 102 may, at a step 146, determine first and second instances of a data structure for storing characteristics of the first and second tasks, respectively. The first and second instances may both include a same plurality of fields for storing values indicative of respective task characteristics. As described in detail below, the workflow management system 102 may create and at least partially populate a work item record having a particular, common format (e.g., a uniform data model). The workflow management system 102 may, for example, use business rules, decision trees, or other machine learning techniques to translate the filtered data into the common data model. The translation techniques may vary depending on the application sourcing the data. The translation may not require all fields of the first instance of the data structure to be populated initially, so null data values may be permitted for at least some fields at least initially.

The workflow management system 102 may, at a step 148, populate a first field of the first instance with a first value, the first field representing a first characteristic. In some implementations, the workflow management system 102 may subsequently populate one or more null data values based on historic data and/or data from other sources. The workflow management system 102 may, for example, store the work item in a metadata store. Examples of such a uniform data model and such a metadata store are described in additional detail below with reference to FIG. 6. The workflow management system 102 may determine, based at least in part on the stored first indication, that the first task is to be performed by a first individual. An example process for selecting an assignee when none has been identified by the requestor 524a is described below with reference to FIG. 8A.

The workflow management system 102 may, at a step 148, send, to a first client device, a message indicating assignment of the first task to a first individual. The workflow management system 102 may cause a client device to output an indication that the first task is to be performed by the first individual; for example, by sending a notification 546 to the client device 202b corresponding to the user 524b (e.g., an assignee). In some implementations, the workflow management system 102 may also determine one or more additional characteristics of the first task—for example, a priority or an estimated size of the task—and may include such additional characteristic(s) in the notification 546. Further, as explained in detail below, workflow management system 102 may receive and process responses to such notifications 546, to achieve additional functionality.

In some implementations, the workflow management system 102 may repeat the steps 144-150 for the user 524b to receive, translate, store, and assign additional data from the application for the user 524a. In some implementations, the workflow management system 102 may likewise repeat the steps for additional applications and/or users 524.

Additional details and example implementations of embodiments of the present disclosure are set forth below in Section F, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

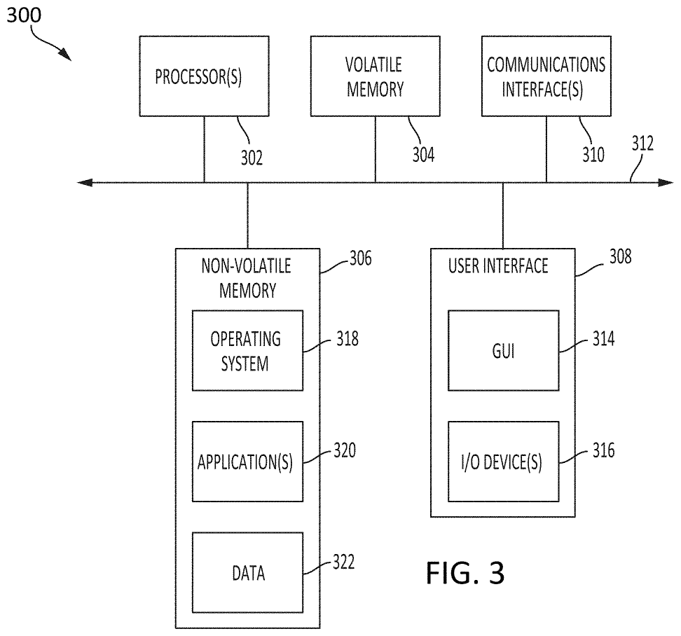

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

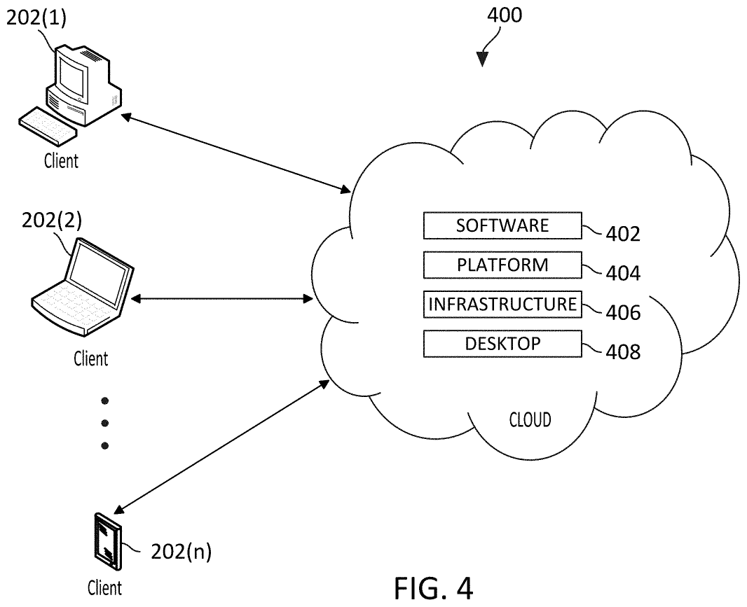

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Managing and Streamlining Access by Client Devices to a Variety of Resources

FIG. 5A is a block diagram of an example multi-resource access system 500 in which one or more resource management services 502 may manage and streamline access by one or more clients 202 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 202 and, following authentication, identify one or more resources the user is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

The client(s) 202 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 202, one or more file repositories and/or file sharing systems, one or more secure browser services, one or more access control services for the SaaS applications 508, one or more management services for local applications on the client(s) 202, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 202) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 202 may use a resource access application 522 to communicate with the client interface service 514 as well as to present a user interface on the client 202 that a user 524 can operate to access the resource feed(s) 504 and/or the SaaS application(s) 508. The resource access application 522 may either be installed on the client 202, or may be executed by the client interface service 514 (or elsewhere in the multi-resource access system 500) and accessed using a web browser (not shown in FIG. 5B) on the client 202.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., username and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 202 to be redirected to the cloud-based identity service to complete an authentication process. The cloud-based identity service may then cause the client 202 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 202 may proceed to access the selected resource.

When the user 524 selects a local application, the resource access application 522 may cause the selected local application to launch on the client 202. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508.

In some embodiments, the preferred browser identified by the gateway service 506 may be a specialized browser embedded in the resource access application 522 (when the resource application is installed on the client 202) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 202, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box labeled “systems of record 526,” and further in which several different services are included within the resource management services block 502. As explained below, the services shown in FIG. 5C may enable the provision of a streamlined resource activity feed and/or notification process for a client 202. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case application made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and 6ML. As explained in more detail below, the data integration provider service 530 may also write back to the systems of record, for example, using OAutXXH2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically pull active data from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAutXXH2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 202 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 202 as a push notification to the user 524.

In some embodiments, a process for processing a user-initiated action via a microapp may operate as follows. The client 202 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted OautXXH2 token for the system of record for which the action is to be invoked, and may send the action to the data integration provider service 530 together with the encrypted OAutXXH2 token. The data integration provider service 530 may then decrypt the OAutXXH2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system or record to which the notification 546 corresponds, thus helping the user understand the proper context with which to decide how best to respond to the notification 546. In some implementations, one of more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D) and/or an “application” mode (not illustrated) may be selected (e.g., using the element 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C above, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user-interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp. In addition to the event-driven actions accessible via the action elements 548 in the notifications 546, a user may alternatively initiate microapp actions by selecting a desired action, e.g., via a drop-down menu accessible using the “action” user-interface element 552 or by selecting a desired action from a list 554 of recently and/or commonly used microapp actions. As shown, the user may also access files (e.g., via a Citrix ShareFile™ platform) by selecting a desired file, e.g., via a drop-down menu accessible using the “files” user interface element 556 or by selecting a desired file from a list 558 of recently and/or commonly used files.

Although not shown in FIG. 5D, it should be appreciated that, in some implementations, additional resources may also be accessed through the screen 540 by clicking on or otherwise selecting one or more other user interface elements that may be presented on the screen. For example, in some embodiments, one or more virtualized applications may be accessible (e.g., via a Citrix Virtual Apps and Desktops™ service) by clicking on or otherwise selecting an “apps” user-interface element (not shown) to reveal a list of accessible applications and/or one or more virtualized desktops may be accessed (e.g., via a Citrix Virtual Apps and Desktops™ service) by clicking on or otherwise selecting a “desktops” user-interface element (not shown) to reveal a list of accessible desktops.

The activity feed shown in FIG. 5D provides significant benefits, as it allows a user to respond to application-specific events generated by disparate systems of record without needing to navigate to, launch, and interface with multiple different native applications.

### F. Detailed Description of Example Embodiments of a Workflow Management System

FIG. 6 is a block diagram of an example implementation of the workflow management system 102 that was introduced above (in Section A) in connection with FIGS. 1A and 1B. As Section A notes, in some implementations, the workflow management system 102 may be embodied within, or operate in conjunction with, the multi-resource access system 500 that is described above in connection with FIGS. 5A through 5D. Further, as described in Section E, in some implementations, the multi-resource access system 500 may include a number of resource management services 502 (e.g., within the cloud computing environment 512) that enable respective functionalities, including allowing client devices 202 to access and/or otherwise interface with applications hosted on one or more systems of record 526. As shown in FIG. 6, to implement the workflow management system 102, the cloud computing environment 512 may additionally include an adapter 610 that may be likewise configured to interface with one or more systems of record 526a, 526b, 526c (collectively, “systems of record 526”), e.g., via respective application programming interfaces (API) 626a, 626b, or 626c (collectively, “APIs 626”). Although not shown in FIG. 6, it should be appreciated that, in some implementations, the adapter 610 may include, or may operate in conjunction with, the data integration provider service 530 described in connection with FIG. 5C, so as to enable access to the systems of record 526 via the APIs 626.

As shown in FIG. 6, in some implementations, the workflow management system 102 may include, or operate in conjunction with, one or more of the resource management services 502 described in Section E, including the microapp service 528 and the notification service 538. Further, as also shown in FIG. 6, the cloud computing environment 512 may additionally include the adapter 610 (which was introduced briefly above), a metadata record service 620, a metadata store 630, and a decision engine 640. In some embodiments, similar to the other components in the cloud computing environment 512, the adapter 610, the metadata record service 620, and the decision engine 640 may be implemented by one or more processors and one or more computer-readable media that is/are encoded with instructions which, when executed by the one or more processors, cause the one or more processors to perform the functions described herein.

The adapter 610 may receive application data from the systems of record 526 and may keep the metadata store 630 in sync with the application data. The adapter 610 may access the application data via, for example, the APIs 626. The adapter 610 may provide stored login credentials (e.g., from the credential wallet service 532) to the systems of record 526 to authorize such access. The credentials may correspond to a particular user, such as a requestor 524a or a assignee 524b. Additionally or alternatively, the credentials may correspond to an organization, such as a customer of the multi-resource access system 500, with whom the user is affiliated.

The adapter 610 may populate the metadata store 630 by loading application data available to it (e.g., from the systems of record 526) into the metadata store 630 (via the metadata record service 620). The adapter 610 may, as part of its initialization process, filter and translate the application data to a common data model for respective data records. The filtering process may include using rules (e.g., predefined or not) and/or machine learning techniques to determine what may be an actionable work item from received data. The translation process may use business rules, decision trees and/or machine learning techniques to convert the filtered data into the common data model. Translation does not require the end data to be complete, so null data values are permitted. The decision engine 640 may subsequently seek to populate null data values based on historic data and/or data from other sources, as described in more detail below. The adapter 610 may use different filtration and translation processes depending on the application from which the data was received. In some implementations, the adapter 610 may additionally receive creation, update, and deletion events provided by the resource management services 502 to keep the metadata store 630 synchronized.

The adapter 610 may implement a configurable set of rules that may, for example, determine how a state in one system of one application can translate to a common format used in the metadata store 630. A first example rule may specify a translation for a work item update that assigns the work item to a group in an implementation where the metadata store 630 does not support assignment to groups: “When a work item assignment is changed in CustomApplication1, if the previous assignee was an employee, and the new assignee is a group, set the assignee to ‘unassigned’ in the metadata store 630.” A second example rule may translate a work item size from a number of days to a size category: “When a work item estimate is set between 4 and 8 days in the metadata store 630, set the ‘size of work’ field in CustomApplication2 to ‘Large’.” FIG. 7A shows an example structure of such rules, and FIG. 7B outlines an example rule.

FIG. 7A is a flowchart illustrating an example structure of a rule 700 for the adapter 610. As shown in FIG. 7A, an event may be received at a step 705. The event may represent, for example, a creation, update, or deletion of a work item. The adapter 610 may apply a Condition A at a decision step 710. In the first example described above, the Condition A could be a determination of whether the previous assignee was an employee. If true, the adapter 610 may proceed to apply a Condition B at a decision step 715. In the first example described above, the Condition B could be a determination of whether the new assignee is a group. If true, the adapter 610 may proceed to the resulting action at a step 720. A resulting action can be, for example, changing an assignee, changing a size or completion date estimate, change a priority, or no action at all, etc. In the first example described above, the resulting action was setting the assignee to ‘unassigned’ in the metadata store 630 (to account for the metadata store 630 not supporting assignment of work items to groups). If the adapter 610 determines, at the decision step 715, that the event does not meet Condition B (false at the decision step 715), the adapter 610 may proceed to the resulting action at a step 725, which may be no further action (e.g., no change to work item metadata based on the event). If the adapter 610 determines, at the decision step 710, that the event does not meet Condition A (false at the decision step 710), the adapter 610 may apply a Condition C at a decision step 730, and may proceed to the resulting action at a step 735 if true, or the resulting action at a step 740 if false.

FIG. 7B is a flowchart illustrating an example rule 750 for the adapter 610. As shown in FIG. 7B, an event may be received at a step 755. In the illustrated example, the event may be an update of a work item assignment. The adapter 610 may apply a first condition at a decision step 760 and may determine whether the event originated in the “Expense” application. If not (false at the decision step 760), the rule 750 may specify at a step 765 that the adapter 610 is to take no further action. If so (true at the decision step 760), the adapter 610 may apply a second condition at decision step 770 and may determine whether the previous assignee type specified with respect to the work item is “employee.” If not (false at the decision step 770), no further action may be taken at a step 775. If so (true at the decision step 770), the adapter 610 may apply a third condition at a decision step 780 and may determine whether the new assignee type is not “employee.” If not (false at the decision step 780), no further action may be taken at a step 785. If so (true at the decision step 770)—for example, because the new assignee type is “group”—the adapter 610 may set the Assignee field to “unassigned” in the work item record at a step 790.

The metadata store 630 may serve as a repository where application data gathered by the workflow management system 102 may be stored. The metadata record service 620 may provide read and write access to the metadata store 630. In some implementations, the metadata record service 620 may additionally provide caching of application data written to and/or read from the metadata store 630. The metadata store 630 may store information such as employee (assignee and/or requestor) resource metadata. The metadata store 630 may store a set of work item records that describe various and diverse kinds of work within an organization. The metadata store 630 may be populated initially by bulk data extraction, and subsequently kept up to date by querying and/or subscribing to (e.g., via the adapter 610 and/or metadata record service 620) various applications executing within the multi-resource access system 500, including on systems of record 526. The metadata store 630 may store historical data such as records of work items previously completed or abandoned.

The metadata store 630 may be implemented in various ways. For example, in some implementations, the metadata store 630 may include a database storing data tables. Table-1 shown below is a first example table that may store records for work items identified as potentially actionable, and any metadata determined for the items:

TABLE 1

| Field | Type | Purpose |
|---|---|---|
| ActionId | Int | Unique identifier for this work item |
| Description | Text | Text description of the action to be done, |
| | | high level, typically 1-2 lines |
| ReporterID | Int | Unique identifier for the employee who |
| | | raised the need for this action to be done |
| AssigneeID | Int | Unique identifier for the employee who is |
| | | planning oncarrying out this action |
| EstimateOfSize | Timespan | Estimate of the size of this action in time, |
| | | e.g. 2 minutes, or 4 months |
| Order | Int | Integer representing the order in which the |
| | | employee is likely to approach this action |
| | | relative to other actions they are expecting |
| | | to carry out |

Table-2 shown below is a second example table that may store Career Data representing data gathered from a Human Resources application on career goals and desired skill sets of employees:

TABLE 2

| Field | Type | Purpose |
|---|---|---|
| EmployeeID | Int | Unique Identifier for the employee this |
| | | career data relates to |
| TargetExperience | String[ ] | A set of strings or labels listing the |
| | | experience this employee wishes to gain |
| TargetSkills | String[ ] | A set of string or labels listing the skills |
| | | this employee wishes to gain |

Table-3 shown below is a third example table that may store Excluded Employees representing employees who may have rejected a work item that was suggested or assigned to them. The table may keep a record of the rejection, which the decision engine 640 may take into account when assigning work items, and may determine not to try and assign it to them again next time it processes this work item.

TABLE 3

| Field | Type | Purpose |
|---|---|---|
| EmployeeId | Int | Unique Identifier for the employee this record |
| | | relates to |
| ActionId | Int | Unique Identifier for the work item this employee |
| | | is not suitable for assignment |

In some implementations, the decision engine 640 may run continually and may iterate over the set of work item records to perform a variety of functions, such as estimating certain values related to work items, prioritizing work items for an assignee, and tracking completion. While the adapter 610 may apply rules and determine a description, a requesting resource, and a required resource for a work item, the adapter 610 may not receive enough information from an application to determine the likely duration that the work item will take nor what other tasks an assignee may choose to do ahead of the work item. Thus, for respective work items, the decision engine 640 may attempt to complete the work item record by, for example, estimating a size in terms of how long the work item will take or how much effort will be involved. For the employee or resource a work item has been assigned to, the decision engine 640 may maintain an ordering of priority against other work items that the assignee or resource has been assigned or has accepted. Furthermore, the decision engine 640 may estimate a completion date based on the priority and estimated size of the work item, and may track whether the requestor 524a is satisfied with the completion date.

When the decision engine 640 estimates a value for a characteristic of a work item, it may trigger a notification to one or more stakeholders (e.g., the requestor 524a, the assignee 524b, a system of record 526, etc.). The notification may inform the stakeholder of an implication of the result. A stakeholder may express satisfaction or dissatisfaction with the result, and may provide a reason. The decision engine 640 may, in response to receiving an indication of dissatisfaction, attempt to resolve the problem by finding an alternative assignee or resource to compete the work item, and/or may notify the assignee of the dissatisfaction and request a new estimate or priority.

In some implementations, the decision engine 640 may receive data from a number of sources. For example, the decision engine 640 may receive data from a human resources management application executing on one of the systems of record 526. The human resources management application may have information for individuals regarding, for example, qualifications, skills, experience, and/or desired types of work. For example, an individual may lack documented experience for a certain type of task at their current employer, but may have a desire to expand their expertise into that area, and may have relevant training, prior experience, and/or supervision that would facilitate such work. The human resources management application may additionally include information regarding who (e.g., which requestors 524a) may assign work to a assignee 524b, and internal or external cost for the assignee 524b (e.g., to allow the decision engine 640 or a requestor 524a to determine whether there would be a difference in cost for assigning a work item to a more senior individual versus a more junior individual). In some implementations, the decision engine 640 may receive information from individuals' calendars; for example, from a calendar application executing on one of the systems of record 526. The decision engine 640 may, for example, determine information relevant to estimating completion dates, such as whether an individual has any upcoming scheduled time off or time devoted to trainings, meetings, or other events that may affect availability for work.

The following describes an example of how a work item record may be created based on an event detected by the adapter 610.

The adapter 610 may query for and/or subscribe to events generated by applications executing in the systems of record 526. When a new work item is created using an application, the adapter 610 may detect the corresponding event. The adapter 610 may create a work item record based on the event. The adapter 610 may populate one or more fields of the work item record based on information from the application. The adapter 610 may send the work item record to the decision engine 640. The decision engine 640 may, via the metadata record service 620, create or modify an entry for the work item record in the metadata store 630. The decision engine 640 may then attempt to populate one or more additional fields of the work item record such as assignment, size and/or priority.

Assignment

A work item record for an event that already indicates an assigned individual may require no further action from the decision engine 640.

If an event indicates no assignment or a group assignment, the decision engine 640 may attempt to designate a suitable assignee. If the event indicates a group assignment, the decision engine 640 may attempt to assign the work item to an individual within the group. The decision engine 640 may use any data sources available to it to inform this decision. The decision engine 640 may leverage a history of work items stored in the metadata store 630. For example, the decision engine 640 may, for work items from the same application or having similar task descriptions, look at the assignees listed at the time of completion, and generate a list of potentially suitable assignees. For example, if individuals A, B, and C are the only ones who have ever completed work items for an application CustomApplication1, then the decision engine 640 may shortlist those three individuals. In some implementations, the decision engine 640 may additionally or alternatively retrieve skills and experience information for individuals from a human resources management application executing on one of the systems of record 526. The decision engine 640 may use information about the number, size and priority of work items currently assigned to each individual A, B and C to rank the candidates based on perceived availability. For example, if individuals A and B have no work items assigned, but individual C has one, the decision engine 640 may eliminate individual C from the shortlist. Once the decision engine 640 can no longer distinguish one individual as more suitable than another to take on the work, it may assign the work item randomly to one of the shortlisted individuals. In some implementations, the decision engine 640 may assign a work item based on information from a human resources (HR) management application, which may be among the systems of record 526, indicating that an individual includes the relevant work type among listed career objectives. Based on the indication that the individual wishes to perform this work type, the decision engine 640 may assign such a work item to the individual despite having no record of the individual having completed work of that type before.

FIG. 8A is a flowchart illustrating an example process 800 for assigning an actionable work item. The adapter 610, at a step 805, may receive data relating to an event from an application executing on one of the systems of record 526. The event may indicate a new actionable work item. If the event indicates an assignee for the work item (yes at a decision step 810), the adapter 610 may populate the assignee field of the record for the work item, and may forward the work item record to the decision engine 640 for priority calculation at a step 815. Priority calculation is described in additional detail below with reference to FIG. 8B. If the event does not indicate an assignee for the work item (no at the decision step 810), the decision engine 640 may attempt to determine an assignee. The decision engine 640 may, at a step 820, receive from the metadata store 630 a list of individuals who have previously completed a task of the type indicated in the work item record. The decision engine 640 may, at a step 825, calculate a score for individuals by adding the estimated effort for work items already in their backlog. The decision engine 640 may, at a step 830, determine the lowest score—e.g., indicating the shortest backlog—and may eliminate from the list any individuals whose score is higher than the lowest score. The decision engine 640 may, at a step 835, assign the work item to the remaining individual or to an individual randomly chosen from the list of remaining individuals. The decision engine 640 may, at a step 815, proceed to calculating priority.

### PRIORITY

In some implementations, the decision engine 640 may assign a priority to a work item. In an example implementation, the decision engine 640 may compare properties of existing work item records in an assignee's list of work items awaiting commencement or completion (e.g., the assignee's backlog). The decision engine 640 may compare a new work item to a work item in the middle of the list. If the decision engine 640 determines that the new work item has a higher priority, the decision engine 640 may repeat the process, but taking into consideration only work items in the list having a higher priority than the middle work item. Conversely, if the decision engine 640 determines that the new work item has a lower priority, the decision engine 640 may repeat the process with only the lower priority work items in the list. In some implementations, such a process may continue recursively until no further comparisons can be made, and the decision engine 640 may set the priority of the new work item relative to the last work item it was compared to. Where the decision engine 640 has no data with which to determine priority, it may prioritize the new work item below work items already in the list.

FIG. 8B is a flowchart illustrating an example process 850 for setting a priority for an actionable work item. In the illustrated example, the decision engine 640 has received a new work item to be assigned to an assignee. The process 850 may begin at a step 855 with the decision engine 640 receiving a list representing the queue of the assignee's assigned work items in priority order. The decision engine 640 may, at a step 860, take a work item from the middle of the list and run, at a decision step 865, one or more comparison rules. Some example comparison rules can be as follows:
If the work items are expense requests, the expense request with the highest value may be considered first.
If the work items have a date field, the work item with the earliest date may be considered first.
Based on historical data in the metadata store 630, if the assignee has previously moved work item with similar properties as the new work item to the top of their priority list, the decision engine 640 may favor the new work item as higher priority. The converse may apply for work items that have historically been moved down the priority list.
If the new work item is from a favored application (e.g., a customer's own application rather than a third-party application operated by a separate entity), the decision engine 640 may treat it as higher priority.
If the new work item has a field relevant to priority, for example an urgency field, the decision engine 640 may take into account a value of the field when comparing priority.

Once the comparison is made at the decision step 865, the decision engine 640 may proceed accordingly. If the decision engine 640 cannot distinguish a priority between the new work item and the one pulled from the list, the decision engine 640 may run the next comparison rule by repeating the decision step 865. If the decision engine 640 applies all rules and yet cannot distinguish the work items, the decision engine 640 may add the new work item just behind the existing work item.

If the decision engine 640 determines, at the decision step 865, that the new work item has a higher priority, the decision engine 640 may remove, at a step 870, the current work item, and all lower priority work items, from the list (but not from the assignee's queue). The decision engine 640 may then determine, at a decision step 875, whether more than one work item remains in the list. If the list includes multiple remaining work items (yes at a decision step 875), the decision engine 640 may return to the step 860 and may repeat the subsequent steps with the reduced list. If the list contains only one remaining work item (no at the decision step 875), the decision engine 640 may add, at a step 880, the work item to the assignee's queue just ahead of the work item just compared to.

If the decision engine 640 determines, at the decision step 865, that the new work item has a lower priority, the decision engine 640 may remove, at a step 885, the current work item, and all higher priority work items, from the list (but again, not from the assignee's queue). The decision engine 640 may then determine, at a decision step 890, whether more than one work item remains in the list. If so (yes at the decision step 890), the decision engine 640 may return to the step 860 and may repeat the subsequent steps with the reduced list. If not (no at the decision step 890), the decision engine 640 may add, at a step 895, the work item to the assignee's queue just behind of the work item just compared to.

Estimated Time to Complete

In some implementations, the decision engine 640 may estimate a size of the new work item in terms of effort or time required to complete. The decision engine 640 may consider information in the metadata store 630, including information about whether the assignee has completed work items of this type before. Additionally or alternatively, the decision engine 640 may consider a requestor estimate, if provided, as well as a historical accuracy of previous requestor estimates.

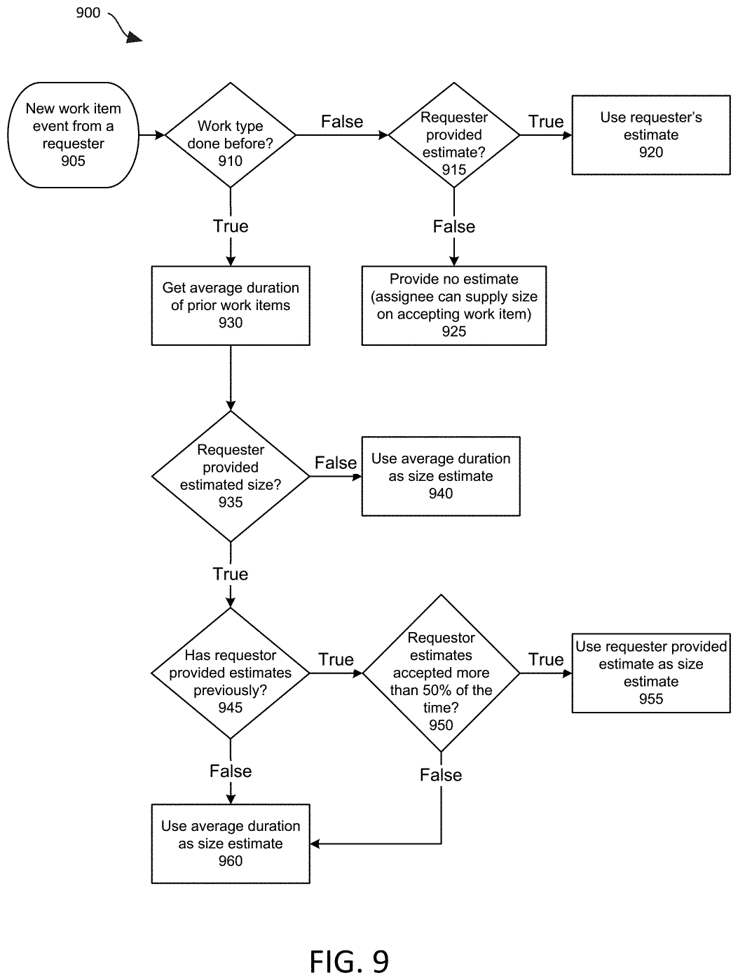

FIG. 9 is a flowchart illustrating an example process 900 for estimating a size of an actionable work item. The decision engine 640 may, at a step 905, receive a new work item from a requestor 524a and assigned to an assignee 524b. The decision engine 640 may determine, at a decision step 910, whether the assignee has done this type of work before. If not (false at the decision step 910), the decision engine 640 may proceed to determine, at a decision step 915, whether the requester 524a has provided a size estimate for the work item. If so (true at the decision step 915), the decision engine 640 may, at a step 920, use the requestor's size estimate for the work item. If not (false at the decision step 915), the decision engine 640 may, at a step 925, refrain from providing a size estimate for the work item. In some implementations, the assignee may provide a size estimate upon accepting the work item.

If the decision engine 640 determines that the assignee has done this type of work before (true at the decision step 910), the decision engine 640 may, at a step 930, calculate an average duration of previous work items recorded in the metadata store 630. The decision engine 640 may determine, at a decision step 935, whether the requestor 524a has provided an estimated size. For example, the work item may include a plurality of fields for storing respective characteristics of the work item such as estimated size, priority, resources required, etc. The decision engine 640 may thus determine whether the estimated size field is populated or whether it includes a null value. If the requestor 524a has not provided an estimate (false at the decision step 935), the decision engine 640 may, at a step 940, use the average duration as the size estimate for the work item. If the requestor 524a has provided an estimate (true at the decision step 935), the decision engine 640 may determine, at a decision step 945, whether the requestor 524a has previously provided estimated sizes for work items. For example, the decision engine 640 may query the metadata store 630 for data related to work items previously submitted by the requestor 524a. The work item records may include fields for initial size estimates as well as total completion time calculated upon marking the work item complete. If the requestor 524a has not provided size estimates in the past (false at the decision step 945), the decision engine 640 may, at a step 960, use the average duration as the size estimate for the work item. If the requestor 524a has provided size estimates in the past (true at the decision step 945), the decision engine 640 may determine, at a decision step 950, whether the requestor's estimates were accepted by the assignee more than a threshold proportion of the time (in this example, half the time). For example, the decision engine 640 may query the metadata store 630 for data related to work items previously submitted by the requestor 524a that include initial size estimates that were modified by assignees 524b. If not (false at the decision step 950), the decision engine 640 may, at a step 960, use the average duration—for example, the mean completion time for similar work items—as the size estimate for the work item. If so (true at the decision step 950) the decision engine 640 may, at a step 955, use the estimate provided by the requestor 524a.

Notifying the Assignee and the Requestor

In some implementations, the decision engine 640 may initiate a notification 546 to the assignee 524b regarding the new work item. The decision engine 640 may, for example, engage the notification service 538 to send the notification 546. The decision engine 640 may provide an estimated size and/or proposed priority, if available, in such a notification. The assignee 524b may receive the notification 546 via the resource access application 522. The notification may appear, for example, similar to one of the notifications 546 displayed within the display screen 540 as described above with regard to FIG. 5D. In some implementations, the notification 546 may offer the assignee three choices for how to respond:
The assignee 524b may reject the work. In some implementations, the assignee 524b may suggest a new assignee. If assignee 524b does not suggest a new assignee, the decision engine 640 may repeat its comparison process with this assignee 524b excluded.
The assignee 524b may accept the work at the suggested priority and/or size estimate, if provided.
The assignee 524b may accept the work, but request a modification of the priority and/or size estimate. The metadata store 630 may record the modifications to the work item record.

In some implementations, the notification 546 may provide one or more links, buttons, or other action elements for responding. By activating one of the action elements, the assignee 524b may invoke a microapp provided by the microapp service 528. The microapp may perform one or more functions depending on the assignee's response. For example, the microapp may send an update to the metadata record service 620 for recording in the metadata store 630. The microapp may send an indication of the response (with an update, if applicable) to the notification service 538 for initiating a notification 546 to the requestor 524a of the assignee's response. The microapp may send an update to an application executing on one or more of the systems of record 526.

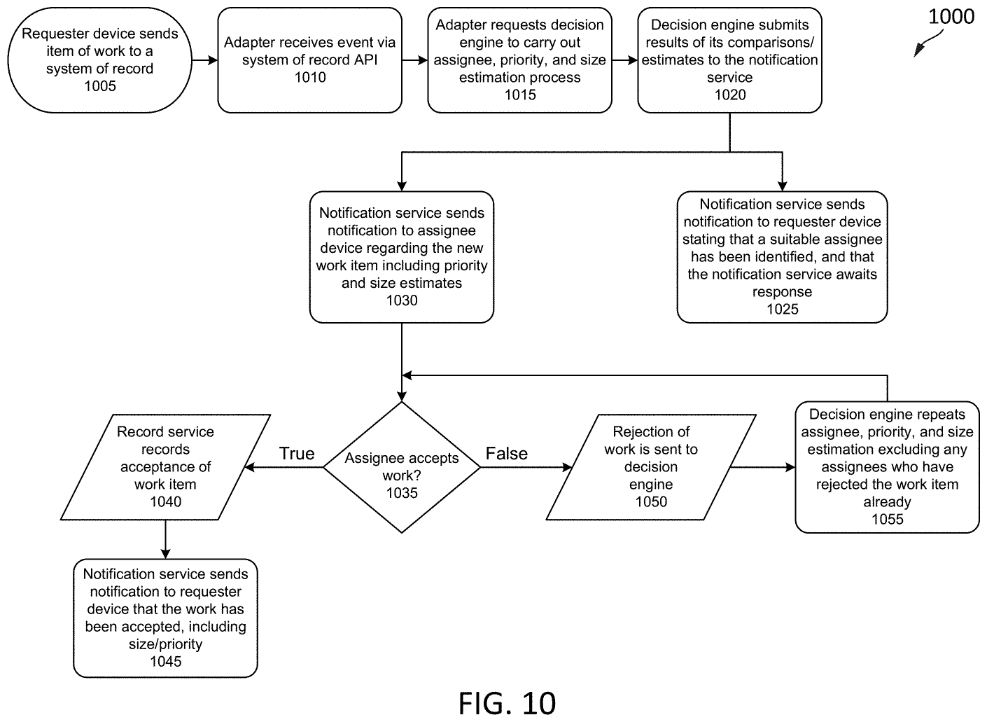

FIG. 10 is a flowchart illustrating an example process 1000 that may be triggered by a change to a work item. As shown in FIG. 10, the process 1000 may begin at a step 1005 with the requestor 524a, e.g., using the resource access application 522, creating a work item using an application executing on a system of record 526. Creation of the work item by the application may trigger an event. The adapter 610 may detect, at a step 1010, the event via the system of record API 626. For example, in some implementations, the adapter 610 may subscribe to push events issued by the applications in the systems of record 526. In some implementations, the adapter 610 may query the APIs 626 for updates from the applications. The adapter 610 may provide a work item record to the decision engine 640, and the decision engine 640 may, at a step 1015, determine one or more of an assignee, a priority, or a size estimate. The decision engine 640 may, at a step 1020, send the results of such determinations to the notification service 538. The notification service 538 may, at a step 1025, send a notification 546 to the requestor device 202a. The notification 546 to the requestor device 202a may, for example, indicate that a suitable assignee has been identified, and that the notification service 538 awaits a response from the assignee's device 202b. In some implementations, the notification 546 may include one or more action elements that enable the requestor 524a to respond to the notification. For example, the requestor 524a may approve of the information in the notification 546, or may respond with an indication that the work item may need to be completed soon, and possibly include an explanation.

The notification service 538 may, at a step 1030, send a notification 546 to the assignee device 202b. The notification 546 may include the priority and/or size estimate, if available, for the work item. The assignee 524b, upon receiving the notification 546, may (at a decision step 1035) accept, decline, or request a modification of the work item. If the assingee accepts the work (true at the decision step 1035), the assignee 524b may invoke a microapp that causes the metadata record service 620 to update, at a step 1040, the record of the work item in the metadata store 630. The microapp may also cause, at a step 1045, the notification service 538 to return a notification 546 to the requestor device 202a that the assignee 524b has accepted the work item. The requestor notification 546 may include the priority and/or estimated size determined by the decision engine 640, and may possibly be subject to any modifications requested by the assignee 524b upon acceptance. If the assignee 524b rejects the work (false at the decision step 1035), the assignee 524b may invoke a microapp that sends, at a step 1050, an indication of the rejection to the decision engine 640. The decision engine 640, upon receiving the rejection, may repeat, at a step 1055, assignee, priority, and/or size estimation processes, this time excluding the assignee 524b (and any other assignees) who have rejected the work item.

Responding to a Change Event

In some implementations, once the workflow management system 102 has created a work item record and notified stakeholders, it may respond to events related to the work item. Such events may include, for example, a reduction of the work item's priority, a removal of the work item's assignee, or an update of an estimated size of the work item. The workflow management system 102 may respond to the events by repeating any of the assignment, priority, and/or size estimation processes described above. If the result is the same assignee, the workflow management system 102 may send a notification 546 to the requestor's device 202a indicating a change in priority. The notification 546 may further indicate a new estimated size and/or a resultant impact on a completion date estimate. If an alternative assignee is identified, the workflow management system 102 may send a notification 546 to the alternative assignee's device 202. The notification 546 may give the alternative assignee 524b an opportunity to respond to the work item. The workflow management system 102 may send a notification 546 to the requestor's device 202a to indicate that the workflow management system 102 has identified an alternative assignee 524b who may take on the work item. The workflow management system 102 may send an additional notification to the requestor's device 202a to indicate whether the alternative assignee 524b has accepted or rejected the work item.

FIG. 11 is a flowchart illustrating an example process 1100 for estimating a size of an actionable work item. The adapter 610 of the workflow management system 102 may detect one or more triggering events at a step 1105. Such triggering events may, for example, include a reduction of the work item's priority at a step 1110, a removal of the work item's assignee at a step 1115, or an update of an estimated size of the work item at a step 1120. The decision engine 640 of the workflow management system 102 may, at a step 1125, repeat one or more of an assignment, priority, and/or size estimation process. The decision engine 640 may determine, at a decision step 1130, whether the assignee of the work item has changed. If not (false at the decision step 1130), the notification service 538 of the workflow management system 102 may, at a step 1135, send a notification 546 to the requestor's device 202a indicating a change of priority and/or an estimated size of the work item. If so (true at the decision step 1130), the notification service 538 may send notifications 546 to both the new assignee's device 202 and the requestor's device 202a indicating the new assignment. The notification service 538 may, at a step 1140, send a notification 546 to the new assignee's device 202 indicating that the assignee has been offered the work item. The notification service 538 may, at a step 1145, send a notification 546 to the requestor's device 202a indicating that the new assignee has been offered the work item. The decision engine 640 may determine, at a decision step 1150, whether the new assignee has accepted the work item. If so (true at the decision step 1150), the notification service 538 may send, at a step 1155, a notification 546 to the requestor's device 202a indicating the new assignee. The notification 546 may include a new priority and/or size estimate. If the new assignee has not accepted the work item (false at the decision step 1150), the decision engine 640 may repeat the process by returning to the step 1125 to determine yet a new alternative assignee, priority, and or size estimate.

In some implementations, the workflow management system 102 may provide requestors 524a (or other managers) additional access to information stored within the system. For example, the metadata record service 620 (or other components of the workflow management system 102 and/or the multi-resource access system 500) may prepare reports based on information in the metadata store 630 for authorized individuals. The reports may include information regarding work item queues for various individuals, records of past assignments, and/or current or historic timeliness of completion. Such reports may help identify individuals who are over- or under-utilized, whether individuals are getting the type of work they desire, whether their skills and experience are expanding over time, etc.

FIG. 12 is a flowchart illustrating an example filtering process 1200 for detecting triggering events in received data. The adapter 610, at a step 1205, may receive an event data set including one or more events. The adapter 610 may receive the event data set as, for example, a push notification from an API 626 from one of the systems of record 526. The adapter 610, at a step 1210, may extract data pertaining to one or more fields of a work item record from an event using natural language processing. The adapter 610, at a decision step 1215, may determine whether an actionable intent can be determined. If so (yes at the decision step 1215), the adapter 610, at a decision step 1220, may determine whether the event is actionable (or, in some cases, potentially actionable). If so (yes at the decision step 1220), the adapter 610, at a step 1225, may send the event to the decision engine 640 for processing. If the adapter 610 determines that the event is not actionable (no at the decision step 1220), the adapter 610, at a step 1230, may drop the event.

Returning to the decision step 1215, if the adapter 610 determines that an actionable intent cannot be determined (no at the decision block 1215), the adapter 610, at a step 1235, may send the event to the decision engine 640 for processing with an additional “dismiss” action. The decision engine 640, at a decision step 1240, may determine whether an assignee or a requestor dismissed a task—e.g., work item—associated with the event. If so (yes at the decision step 1240), the decision engine 640, at a step 1245, may send a positive confirmation to the adapter 610. If the decision engine 640 cannot determine whether and assignee or a requestor has dismissed the task (no at the decision step 1240), the decision engine 640, at a step 1250, may send a negative confirmation to the adapter 610. The adapter 610 may use the positive and/or negative confirmations to refine a trainable model for filtering events. The following three examples illustrate operations of the adapter 610 and the decision engine 640 upon receiving event data.

The following examples illustrate the operations of a workflow management system 102 that includes a messaging application executing in one of the systems of record 526. An adapter 610 of the workflow management system 102 may include a filtration component having natural language processing (NLP) capabilities to identify intent from a data set; for example, a dataset including event data received from a system of record 526. As the adapter 610 converts the events into the common data model, the adapter 610 may attempt to extract from a communication, among other things, data relevant to fields of a work item record; for example, an intended assignee, an expected completion data, a task, and a priority. In a first example, the adapter 610 may determine an actionable intent from the event. In the first example, a user may send the following message via the messaging application:

Ravi: “Hi Jason, please can you create another 3-D model for the latest widget version?”

The adapter 610 may receive this message and may apply its rules for the messaging application to extract information from the message to populate a uniform data model for a work item record, as shown in the example Table-4 shown below:

TABLE 4

| | | | | | |
|---|---|---|---|---|---|
| Item | Requesting | Required | Work Item | Priority for | |
| Description | Resource | Resource(s) | Duration | Resource(s) | State |

| | | | |
|---|---|---|---|
| Create another | Ravi | Jason | Incomplete |
| 3-D model for | | | |
| the latest | | | |
| widget version | | | |

In the first example, the adapter 610 determines that the message relates to an actionable work item. The adapter 610 may determine the description, a requestor (Ravi), and a required resource (Jason); however, there is not enough information in the message or the messaging application to determine the likely duration the actionable work item will take to complete, nor what other tasks Jason may choose to perform ahead of this task. The adapter 610 may send data representing the event to a decision engine 640 of the workflow management system 102 for determination/estimation of additional data for populating fields of the work item record.

The decision engine 640 may take steps to determine and/or estimate information to populate the empty fields in the work item record. The decision engine 640 may, for example, use other metadata to determine that the assignee has three similar work items for which he is the required resource, and the duration of individual work items is one day. The decision engine 640 may also find that the work items use a “3-D model maker” resource. Accordingly, the decision engine 640 may complete the empty fields in the work item record by adding ‘1 day’ to the work item duration, ‘4’ to the priority, and “3-D model maker” to the required resources. The completed work item record, including the new metadata determined and/or estimated by the decision engine 640, may appear as in the example Table-5 shown below:

TABLE 5

| Item | Requesting | Required | Work Item | Priority for | |
|---|---|---|---|---|---|
| Description | Resource | Resource(s) | Duration | Resource(s) | State |
| Create another | Ravi | Jason, 3-D | 1 day | 4 | Incomplete |
| 3-D model for | | Model maker | | | |
| the latest | | | | | |
| widget version | | | | | |

The notification service 538 within the resource management services 502 may send a notification 546 to a device 202b associated with Jason regarding the new work item, and likewise send a notification 546 to a device 202a associated with Ravi. The notification 546 sent to Ravi may indicate that the work item will likely be delivered in “4” days. The notification 546 may allow Ravi to protest these estimates. In the event that Ravi protests the priority. The decision engine 640 may look for other people or resources that can complete the work item. For example, the workflow management system 102 may have access to the records of an HR management application or database residing in, for example, one of the systems of record 526. The decision engine 640 may query the HR management application for individuals' records, which may indicate an individual's experience as well as experience and/or skills the individual wishes to acquire. The decision engine 640 may, based on records from the HR management application and/or work item records in the metadata store 630, determine that only Jason has completed such items in the past; however, using data from the HR management application executing on a system of record 526, the decision engine 640 may determine that another individual, Sarah, has expressed an interest in creating 3-D models and is available immediately. The decision engine 640 may update the metadata in the work item record to replace Jason with Sarah, may update the priority from ‘4’ to “1,’ and may send a notification 546 to the device 202a informing Ravi of the change. Ravi may again be invited to protest, but chooses not to, being satisfied with the new estimated delivery time for the date by which the requested 3-D model will be delivered.

In a second example, the adapter 610 may determine that an event does not relate to an actionable intent. In the second example, a user may send the following message via the messaging application:
Ravi: “Hi Jason, thanks for completing the latest widget update.”
   The adapter 610 may receive this message and may apply its rules for the messaging application to extract information from the message, as shown in the example Table-6 shown below:

TABLE 6

| | | | | | |
|---|---|---|---|---|---|
| Item | Requesting | Required | Work Item | Priority for | |
| Description | Resource | Resource(s) | Duration | Resource(s) | State |

| | | |
|---|---|---|
| Thanks for | Ravi | “Completing” - |
| completing the | | gives |
| latest widget | | indication of |
| update | | state |

In the second example, the adapter 610 determines that the message is non-actionable. The adapter 610 may therefore send no event to the decision engine 640.

In a third example, the adapter 610 may determine that an event is potentially actionable. In the third example, a user may send the following message via the messaging application:
Ravi: “Hi Jason, the latest widget version is broken.”
   The adapter 610 may receive this message and may apply its rules for the messaging application to extract information from the message, as shown in the example Table-7 shown below:

TABLE 7

| | | | | | |
|---|---|---|---|---|---|
| Item | Requesting | Required | Work Item | Priority for | |
| Description | Resource | Resource(s) | Duration | Resource(s) | State |

| | | | |
|---|---|---|---|
| The latest | Ravi | Jason | “broken” - |
| widget version | | | indicates |
| is broken | | | incomplete |

In the third example, the adapter 610 determines that the message represents a potentially actionable event. The adapter 610 may therefore send an event to the decision engine 640 with an additional field indicating that the actionable task is an assumption. Based on this additional field, the workflow management system 102 may give either or both the requestor and the assignee an option to dismiss the event as non-actionable. Such feedback from the requestor and/or the assignee can be used to train a machine learning component of the adapter 610 to improve accuracy of future determinations of actionability.

G. Example Implementations of Methods, Systems, and Computer-Readable Media in Accordance with the Present Disclosure

The following paragraphs (M1) through (M14) describe examples of methods that may be implemented in accordance with the present disclosure.

(M1) A method may involve receiving, by a computing system, at least first data from a first application and second data from a second application, wherein the first data has a first format and is indicative of a first task, and the second data has a second format, different from the first format, and is indicative of a second task; determining, based at least in part on a first characteristic of the first data, a first client device to which a first indication of the first task is to be provided; and sending, to the first client device, the first indication, the first indication having a same format as a second indication of the second task sent to the first client device or a second client device, the same format providing a uniform presentation of information relating to the first and second tasks.

(M2) A method may be performed as described in paragraph (M1), and may further involve causing the first client device to output the first indication and the second indication in a list of notifications such that the first indication and the second indication share at least one visual characteristic.

(M3) A method may be performed as described in paragraph (M1) or paragraph (M2), and may further involve determining that the first data is a message sent via a messaging application; and determining the first characteristic by determining a recipient of the message, the recipient being a first individual associated with the first client device.

(M4) A method may be performed as described in paragraphs (M1) through (M3), and may further involve determining, by the computing system and based at least in part on information not received from the first application, at least one additional characteristic of the first task.

(M5) A method may be performed as described in any of paragraphs (M1) through (M4), and may further involve determining at least a second characteristic of the first task; and causing the first client device to output a third indication of the second characteristic with the first indication.

(M6) A method may be performed as described in any of paragraphs (M1) through (M5), and may further involve determining at least a second characteristic of the first task; causing the first client device to output a third indication of the second characteristic with the first indication; receiving, from the first client device, a response to the first indication, the response indicating a request to modify the second characteristic of the first task; and modifying, by the computing system, a stored indication of the second characteristic.

(M7) A method may be performed as described in any of paragraphs (M1) through (M6), and may further involve receiving, from the first client device, a response to the first indication; and activating, based on the response, a microapp, wherein the microapp performs at least one action in accordance with the response.

(M8) A method may be performed as described in any of paragraphs (M1) through (M7), and may further involve storing third data representing login credentials associated with the first client device, wherein the login credentials correspond to one or more of a first individual associated with the client device or an organization with which the first individual is affiliated; sending the third data to the first application; and receiving the first data from the first application subject to the first application validating the second data.

(M9) A method may involve receiving, by a computing system, at least first data from a first application and second data from a second application, wherein the first data has a first format and is indicative of a first task, and the second data has a second format, different from the first format, and is indicative of a second task; determining first and second instances of a data structure for storing characteristics of the first and second tasks, respectively, wherein the first and second instances both include a same plurality of fields for storing values indicative of respective task characteristics; populating a first field of the first instance with a first value, the first field representing a first characteristic of the first task; and sending, to a first client device, a first message indicating assignment of the first task to a first individual.

(M10) A method may be performed as described in paragraph (M9), and may further involve receiving, from the first client device, a response to the first message, the response indicating a request to modify a second characteristic of the first task; and modifying, by the computing system, a stored value of the second characteristic.

(M11) A method may be performed as described in paragraph (M9) or paragraph (M10), and may further involve receiving, from the first client device, a response to the first message; and activating, based on the response, a microapp, wherein the microapp performs at least one action in accordance with the response.

(M12) A method may be performed as described in paragraphs (M9) through (M11), and may further involve processing the first data to determine at least the first value; and determining, based at least in part on the first value, that the first task is to be assigned to the first individual.

(M13) A method may be performed as described in paragraphs (M9) through (M12), and may further involve determining that the first data is a second message sent via a messaging application; and determining the first characteristic by determining a recipient of the second message, the recipient being the first individual.

(M14) A method may be performed as described in paragraphs (M9) through (M13), and may further involve determining, by the computing system and based at least in part on information not received from the first application, at least one additional characteristic of the first task.

The following paragraphs (S1) through (S14) describe examples of systems and devices that may be implemented in accordance with the present disclosure.

(S1) A system may comprise at least one processor and at least one computer-readable medium encoded with instructions which, when executed by the at least one processor, cause the computing system to: receive, by a computing system, at least first data from a first application and second data from a second application, wherein the first data has a first format and is indicative of a first task, and the second data has a second format, different from the first format, and is indicative of a second task; determine, based at least in part on a first characteristic of the first data, a first client device to which a first indication of the first task is to be provided; and send, to the first client device, the first indication, the first indication having a same format as a second indication of the second task sent to the first client device or a second client device, the same format providing a uniform presentation of information relating to the first and second tasks.

(S2) A system may be configured as described in paragraph (S1), wherein the at least one computer-readable medium is further encoded with additional instructions which, when executed by the at least one processor, further cause the computing system to: cause the first client device to output the first indication and the second indication in a list of notifications such that the first indication and the second indication share at least one visual characteristic.

(S3) A system may be configured as described in paragraph (S1) or paragraph (S2), wherein the at least one computer-readable medium is further encoded with additional instructions which, when executed by the at least one processor, further cause the computing system to: determine that the first data is a message sent via a messaging application; and determine the first characteristic by determining a recipient of the message, the recipient being a first individual associated with the first client device.

(S4) A system may be configured as described in any of paragraphs (S1) through (S3), wherein the at least one computer-readable medium is further encoded with additional instructions which, when executed by the at least one processor, further cause the computing system to: determine, based at least in part on information not received from the first application, at least one additional characteristic of the first task.

(S5) A system may be configured as described in any of paragraphs (S1) through (S4), wherein the at least one computer-readable medium is further encoded with additional instructions which, when executed by the at least one processor, further cause the computing system to: determine at least a second characteristic of the first task; and cause the first client device to output a third indication of the second characteristic with the first indication.

(S6) A system may be configured as described in any of paragraphs (S1) through (S5), wherein the at least one computer-readable medium is further encoded with additional instructions which, when executed by the at least one processor, further cause the computing system to: determine at least a second characteristic of the first task; causing the first client device to output a third indication of the second characteristic with the first indication; receive, from the first client device, a response to the first indication, the response indicating a request to modify the second characteristic of the first task; and modify a stored indication of the second characteristic.

(S7) A system may be configured as described in any of paragraphs (S1) through (S6), wherein the at least one computer-readable medium is further encoded with additional instructions which, when executed by the at least one processor, further cause the computing system to: receive, from the first client device, a response to the first indication; and activate, based on the response, a microapp, wherein the microapp performs at least one action in accordance with the response.

(S8) A system may be configured as described in any of paragraphs (S1) through (S7), wherein the at least one computer-readable medium is further encoded with additional instructions which, when executed by the at least one processor, further cause the computing system to: store third data representing login credentials associated with the first client device, wherein the login credentials correspond to one or more of a first individual associated with the client device or an organization with which the first individual is affiliated; send the third data to the first application; and receive the first data from the first application subject to the first application validating the second data.

(S9) A system may comprise at least one processor and at least one computer-readable medium encoded with instructions which, when executed by the at least one processor, cause the computing system to: receive at least first data from a first application and second data from a second application, wherein the first data has a first format and is indicative of a first task, and the second data has a second format, different from the first format, and is indicative of a second task; determine first and second instances of a data structure for storing characteristics of the first and second tasks, respectively, wherein the first and second instances both include a same plurality of fields for storing values indicative of respective task characteristics; populate a first field of the first instance with a first value, the first field representing a first characteristic of the first task; and send, to a first client device, a first message indicating assignment of the first task to a first individual.

(S10) A system may be configured as described in paragraph (S9), wherein the at least one computer-readable medium is further encoded with additional instructions which, when executed by the at least one processor, further cause the computing system to: receive, from the first client device, a response to the first message, the response indicating a request to modify a second characteristic of the first task; and modify, by the computing system, a stored value of the second characteristic.

(S11) A system may be configured as described in paragraph (S9) or paragraph (S10), wherein the at least one computer-readable medium is further encoded with additional instructions which, when executed by the at least one processor, further cause the computing system to: receive, from the first client device, a response to the first message; and activate, based on the response, a microapp, wherein the microapp performs at least one action in accordance with the response.

(S12) A system may be configured as described in any of paragraphs (S9) through (S11), wherein the at least one computer-readable medium is further encoded with additional instructions which, when executed by the at least one processor, further cause the computing system to: process the first data to determine at least the first value; and determine, based at least in part on the first value, that the first task is to be assigned to the first individual.

(S13) A system may be configured as described in any of paragraphs (S9) through (S12), wherein the at least one computer-readable medium is further encoded with additional instructions which, when executed by the at least one processor, further cause the computing system to: determine that the first data is a second message sent via a messaging application; and determine the first characteristic by determining a recipient of the second message, the recipient being the first individual.

(S14) A system may be configured as described in any of paragraphs (S9) through (S13), wherein the at least one computer-readable medium is further encoded with additional instructions which, when executed by the at least one processor, further cause the computing system to: determine, by the computing system and based at least in part on information not received from the first application, at least one additional characteristic of the first task.

The following paragraphs (CRM1) through (CRM14) describe examples of computer-readable media that may be implemented in accordance with the present disclosure.

(CRM1) At least one non-transitory, computer-readable medium may be encoded with instructions which, when executed by at least one processor included in a computing system, cause the computing system to receive, by a computing system, at least first data from a first application and second data from a second application, wherein the first data has a first format and is indicative of a first task, and the second data has a second format, different from the first format, and is indicative of a second task; determine, based at least in part on a first characteristic of the first data, a first client device to which a first indication of the first task is to be provided; and send, to the first client device, the first indication, the first indication having a same format as a second indication of the second task sent to the first client device or a second client device, the same format providing a uniform presentation of information relating to the first and second tasks.

(CRM2) At least one computer-readable medium may be configured as described in (CRM1), and may be further encoded with additional instructions which, when executed by the at least one processor, further cause the computing system to cause the first client device to output the first indication and the second indication in a list of notifications such that the first indication and the second indication share at least one visual characteristic.

(CRM3) At least one computer-readable medium may be configured as described in paragraph (CRM1) or paragraph (CRM2), and may further be encoded with additional instructions which, when executed by the at least one processor, further cause the computing system to determine that the first data is a message sent via a messaging application; and determine the first characteristic by determining a recipient of the message, the recipient being a first individual associated with the first client device.

(CRM4) At least one computer-readable medium may be configured as described in any of paragraphs (CRM1) through (CRM3), and may be further encoded with additional instructions which, when executed by the at least one processor, further cause the computing system to determine, based at least in part on information not received from the first application, at least one additional characteristic of the first task.

(CRM5) At least one computer-readable medium may be configured as described in any of paragraphs (CRM1) through (CRM4), and may further be encoded with additional instructions which, when executed by the at least one processor, further cause the computing system to determine at least a second characteristic of the first task; and cause the first client device to output a third indication of the second characteristic with the first indication.

(CRM6) At least one computer-readable medium may be configured as described in any of paragraphs (CRM1) through (CRM5), and may further be encoded with additional instructions which, when executed by the at least one processor, further cause the computing system to determine at least a second characteristic of the first task; causing the first client device to output a third indication of the second characteristic with the first indication; receive, from the first client device, a response to the first indication, the response indicating a request to modify the second characteristic of the first task; and modify a stored indication of the second characteristic.

(CRM7) At least one computer-readable medium may be configured as described in any of paragraphs (CRM1) through (CRM6), and may be further encoded with additional instructions which, when executed by the at least one processor, further cause the computing system to receive, from the first client device, a response to the first indication; and activate, based on the response, a microapp, wherein the microapp performs at least one action in accordance with the response.

(CRM8) At least one computer-readable medium may be configured as described in any of paragraphs (CRM1) through (CRM7), and may further be encoded with additional instructions which, when executed by the at least one processor, further cause the computing system to store third data representing login credentials associated with the first client device, wherein the login credentials correspond to one or more of a first individual associated with the client device or an organization with which the first individual is affiliated; send the third data to the first application; and receive the first data from the first application subject to the first application validating the second data.

(CRM9) At least one non-transitory, computer-readable medium may be encoded with instructions which, when executed by at least one processor included in a computing system, cause the computing system to receive at least first data from a first application and second data from a second application, wherein the first data has a first format and is indicative of a first task, and the second data has a second format, different from the first format, and is indicative of a second task; determine first and second instances of a data structure for storing characteristics of the first and second tasks, respectively, wherein the first and second instances both include a same plurality of fields for storing values indicative of respective task characteristics; populate a first field of the first instance with a first value, the first field representing a first characteristic of the first task; and send, to a first client device, a first message indicating assignment of the first task to a first individual.

(CRM10) At least one computer-readable medium may be configured as described in (CRM9), and may be further encoded with additional instructions which, when executed by the at least one processor, further cause the computing system to receive, from the first client device, a response to the first message, the response indicating a request to modify a second characteristic of the first task; and modify, by the computing system, a stored value of the second characteristic.

(CRM11) At least one computer-readable medium may be configured as described in paragraph (CRM1) or paragraph (CRM10), and may further be encoded with additional instructions which, when executed by the at least one processor, further cause the computing system to receive, from the first client device, a response to the first message; and activate, based on the response, a microapp, wherein the microapp performs at least one action in accordance with the response.

(CRM12) At least one computer-readable medium may be configured as described in any of paragraphs (CRM9) through (CRM11), and may be further encoded with additional instructions which, when executed by the at least one processor, further cause the computing system to process the first data to determine at least the first value; and determine, based at least in part on the first value, that the first task is to be assigned to the first individual.

(CRM13) At least one computer-readable medium may be configured as described in any of paragraphs (CRM9) through (CRM12), and may be further encoded with additional instructions which, when executed by the at least one processor, further cause the computing system to determine that the first data is a second message sent via a messaging application; and determine the first characteristic by determining a recipient of the second message, the recipient being the first individual.

(CRM14) At least one computer-readable medium may be configured as described in any of paragraphs (CRM9) through (CRM13), and may be further encoded with additional instructions which, when executed by the at least one processor, further cause the computing system to determine, by the computing system and based at least in part on information not received from the first application, at least one additional characteristic of the first task.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by a computing system, at least first data from a first application and second data from a second application, wherein the first data has a first format and is indicative of a first task, and the second data has a second format, different from the first format, and is indicative of a second task;
determining, based at least in part on a first characteristic of the first data, a first client device to which a first indication of the first task is to be provided; and
sending, to the first client device, the first indication, the first indication having a same format as a second indication of the second task sent to the first client device or a second client device, the same format providing a uniform presentation of information relating to the first and second tasks.

2. The method of claim 1, further comprising:
causing the first client device to output the first indication and the second indication in a list of notifications such that the first indication and the second indication share at least one visual characteristic.

3. The method of claim 1, further comprising:
determining that the first data is a message sent via a messaging application; and
determining the first characteristic by determining a recipient of the message, the recipient being a first individual associated with the first client device.

4. The method of claim 1, further comprising:
determining, by the computing system and based at least in part on information not received from the first application, at least one additional characteristic of the first task.

5. The method of claim 1, further comprising:
determining at least a second characteristic of the first task; and
causing the first client device to output a third indication of the second characteristic with the first indication.

6. The method of claim 1, further comprising:
determining at least a second characteristic of the first task;
causing the first client device to output a third indication of the second characteristic with the first indication;
receiving, from the first client device, a response to the first indication, the response indicating a request to modify the second characteristic of the first task; and
modifying, by the computing system, a stored indication of the second characteristic.

7. The method of claim 1, further comprising:
receiving, from the first client device, a response to the first indication; and
activating, based on the response, a microapp,
wherein the microapp performs at least one action in accordance with the response.

8. The method of claim 1, further comprising:
storing third data representing login credentials associated with the first client device, wherein the login credentials correspond to one or more of a first individual associated with the client device or an organization with which the first individual is affiliated;
sending the third data to the first application; and
receiving the first data from the first application subject to the first application validating the second data.

9. The method of claim 1, further comprising:
determining first and second instances of a data structure for storing characteristics of the first and second tasks, respectively, wherein the first and second instances both include a same plurality of fields for storing values indicative of respective task characteristics;
populating a first field of the first instance with a first value, the first field representing a first characteristic of the first task; and
sending, to a first client device, a first message including the first indication and indicating assignment of the first task to a first individual.

10. The method of claim 9, further comprising:
receiving, from the first client device, a response to the first message, the response indicating a request to modify a second characteristic of the first task; and
modifying, by the computing system, a stored value of the second characteristic.

11. The method of claim 9, further comprising:
receiving, from the first client device, a response to the first message; and
activating, based on the response, a microapp,
wherein the microapp performs at least one action in accordance with the response.

12. The method of claim 9, further comprising:
processing the first data to determine at least the first value; and
determining, based at least in part on the first value, that the first task is to be assigned to the first individual.

13. The method of claim 9, further comprising:
determining that the first data is a second message sent via a messaging application; and
determining the first characteristic by determining a recipient of the second message, the recipient being the first individual.

14. The method of claim 9, further comprising:
determining, by the computing system and based at least in part on information not received from the first application, at least one additional characteristic of the first task.

15. A computing system comprising at least one processor and at least one computer-readable medium encoded with instructions which, when executed by the at least one processor, cause the computing system to:
receive, by a computing system, at least first data from a first application and second data from a second application, wherein the first data has a first format and is indicative of a first task, and the second data has a second format, different from the first format, and is indicative of a second task;
determine, based at least in part on a first characteristic of the first data, a first client device to which a first indication of the first task is to be provided; and
send, to the first client device, the first indication, the first indication having a same format as a second indication of the second task sent to the first client device or a second client device, the same format providing a uniform presentation of information relating to the first and second tasks.

16. The computing system of claim 15, wherein the at least one computer-readable medium is further encoded with additional instructions which, when executed by the at least one processor, further cause the computing system to:
cause the first client device to output the first indication and the second indication in a list of notifications such that the first indication and the second indication share at least one visual characteristic.

17. The computing system of claim 15, wherein the at least one computer-readable medium is further encoded with additional instructions which, when executed by the at least one processor, further cause the computing system to:
determine that the first data is a message sent via a messaging application; and
determine the first characteristic by determining a recipient of the message, the recipient being a first individual associated with the first client device.

18. The computing system of claim 15, wherein the at least one computer-readable medium is further encoded with additional instructions which, when executed by the at least one processor, further cause the computing system to:
determine, based at least in part on information not received from the first application, at least one additional characteristic of the first task.

19. The computing system of claim 15, wherein the at least one computer-readable medium is further encoded with additional instructions which, when executed by the at least one processor, further cause the computing system to:
determine at least a second characteristic of the first task; and
cause the first client device to output a third indication of the second characteristic with the first indication.

20. The computing system of claim 15, wherein the at least one computer-readable medium is further encoded with additional instructions which, when executed by the at least one processor, further cause the computing system to:
determine at least a second characteristic of the first task;
causing the first client device to output a third indication of the second characteristic with the first indication;
receive, from the first client device, a response to the first indication, the response indicating a request to modify the second characteristic of the first task; and
modify a stored indication of the second characteristic.
